(19) United States
(12) Patent Application Publication
(10) Pub. No.: US 2026/0350280 A1
(43) Pub. Date: Nov. 5, 2026

(54) CHARGE TRANSPORT CHARACTERISTIC CALCULATION METHOD AND CHARGE TRANSPORT CHARACTERISTIC CALCULATION DEVICE

(71) Applicant: SONY SEMICONDUCTOR SOLUTIONS CORPORATION, KANAGAWA (JP)

(72) Inventors: FUTO HASHIMOTO, KANAGAWA (JP); JUN KOMACHI, KANAGAWA (JP)

(21) Appl. No.: 19/485,989

(22) PCT Filed: May 30, 2024
(86) PCT No.: PCT/JP2024/019935

§ 371 Date: Nov. 19, 2025

(30) Foreign Application Priority Data
Jun. 5, 2023 (JP) 2023-092643

(51) Int. Cl. G06F 30/32

(52) U.S. Cl. CPC G06F 30/32

(57) ABSTRACT

To accurately calculate a charge transport characteristic with a small calculation amount.

A charge transport characteristic calculation method includes: a procedure of calculating an electrostatic potential of an electronic device; a procedure of extracting a plurality of metastable points in an electrostatic potential field of the electronic device; a procedure of extracting a plurality of paths for transporting a charge from a charge generation position to a charge readout position of the electronic device via the plurality of metastable points in the electrostatic potential field; a procedure of calculating a physical quantity of the electrostatic potential field in each of the plurality of paths; and a procedure of calculating a charge transport characteristic from the charge generation position to the charge readout position on a basis of the physical quantity of the electrostatic potential field in each of the plurality of paths.

### TECHNICAL FIELD

The present disclosure relates to a charge transport characteristic calculation method and a charge transport characteristic calculation device.

### BACKGROUND ART

With recent increase in development cost of electronic devices, importance of simulation for improving development efficiency in design and development of the electronic devices is increasing. One simulation in the design and development of the electronic devices is a device simulation that simulates an electrical characteristic of the electronic device.

In this device simulation, it is necessary to analyze charge behavior in an electrostatic potential field in the electronic device, that is, a charge transport characteristic (see Patent Documents 1 and 2). For example, Patent Document 1 proposes a simulation method that enables high-speed calculation by applying a Monte Carlo method in a region where an existence probability of charge particles is low and applying a repetition method in a region where the existence probability is high.

### CITATION LIST

### Patent Document

Patent Document 1: Japanese Patent Application Laid-Open No. H9-245018
Patent Document 2: Japanese Patent Application Laid-Open No. H11-204383

### SUMMARY OF THE INVENTION

### Problems to be Solved by the Invention

However, in the simulation methods of Patent Documents 1 and 2, since the charge transport characteristic in an entire path of the electrostatic potential field of the electronic device is analyzed, there is a problem that a calculation amount increases and the charge transport characteristic cannot be accurately calculated in a short time.

Therefore, the present disclosure provides a charge transport characteristic calculation method and a charge transport characteristic calculation device capable of accurately calculating a charge transport characteristic with a small calculation amount.

### Solutions to Problems

In order to solve the above problems, according to the present disclosure, there is provided a charge transport characteristic calculation method including:
a procedure of calculating an electrostatic potential of an electronic device;
a procedure of extracting a plurality of metastable points in an electrostatic potential field of the electronic device;
a procedure of extracting a plurality of paths for transporting a charge from a charge generation position to a charge readout position of the electronic device via the plurality of metastable points in the electrostatic potential field;
a procedure of calculating a physical quantity of the electrostatic potential field in each of the plurality of paths; and
a procedure of calculating a charge transport characteristic from the charge generation position to the charge readout position on a basis of the physical quantity of the electrostatic potential field in each of the plurality of paths.

The metastable point may be a minimum point of the electrostatic potential field.

The charge transported by the electronic device may be a positive charge or a negative charge, and
the metastable point may be a minimum point of the electrostatic potential of the electronic device in a case where the electronic device transports the negative charge, and may be a minimum point after sign inversion of the electrostatic potential of the electronic device in a case where the electronic device transports the positive charge.

The charge for which the charge transport characteristic is calculated may be at least one of a hole, a cation, an electron, or an anion.

In the procedure of extracting the plurality of metastable points, a plurality of the minimum points may be extracted according to a gradient of an electric field of the electrostatic potential field.

In the procedure of extracting the plurality of metastable points, a plurality of initial points may be set in the electrostatic potential field, and all the minimum points in the electrostatic potential field may be extracted on a basis of the electric field at the plurality of initial points.

In the procedure of extracting the plurality of metastable points, the electrostatic potential field may be mesh-divided, and points at which an electric field at each lattice point of a mesh is zero and a differential value of the electric field is positive may be extracted as the metastable points.

In the procedure of extracting the plurality of metastable points, an equipotential surface having a same potential may be moved while changing the potential in the electrostatic potential field of the electronic device, and a portion where at least a part of the equipotential surface disappear may be extracted as the metastable point.

In the procedure of extracting the plurality of metastable points, the equipotential surface may be moved to extract the metastable points in a predetermined space region in which the charge generated in the electronic device is movable.

In the procedure of extracting the plurality of metastable points, the equipotential surface may be moved within a predetermined potential range in the electrostatic potential field to extract the metastable points.

In the procedure of extracting the plurality of metastable points, in a case where a plurality of the portions exists on the equipotential surface, a barrier representing a magnitude of a charge transfer obstacle may be extracted from among the plurality of portions.

In the procedure of extracting the plurality of metastable points, the plurality of metastable points located around the barrier having a predetermined height or less may be combined.

In the procedure of extracting the plurality of paths, the plurality of paths may be extracted from a peak position of the barrier on a basis of a gradient method.

In the procedure of extracting the plurality of paths, the plurality of paths may be extracted from the peak position of the barrier having a predetermined height or less on a basis of a gradient method.

In the procedure of extracting the plurality of paths, the plurality of paths may be extracted by using a nudged elastic band (NEB) method, a string method, a conjugate peak refinement (CPR) method, a ridge method, or a Dewar, Healy, and Stewart (DHS) method.

In the procedure of extracting the plurality of paths, the plurality of paths may be extracted by using a drag method.

In the procedure of extracting the plurality of paths, a path having a smaller electrostatic potential may be preferentially selected from among paths between any two metastable points included in the plurality of metastable points to extract the plurality of paths.

In the procedure of calculating the physical quantity, a barrier representing a magnitude of a charge transfer obstacle in each of the plurality of extracted paths may be calculated as the physical quantity.

In the procedure of calculating the physical quantity, resistance values of the plurality of paths in a circuit model corresponding to the electrostatic potential field may be calculated as the barrier.

In the procedure of calculating the charge transport characteristic, a combined resistance value obtained by combining the resistance values of the plurality of paths in the circuit model may be calculated.

In the procedure of calculating the charge transport characteristic, the combined resistance value may be calculated in consideration of the resistance value less than a predetermined threshold without considering the resistance value greater than or equal to the predetermined threshold.

In the procedure of calculating the charge transport characteristic, the charge transport characteristic may be calculated on a basis of a value obtained by multiplying physical quantities of the plurality of paths by probabilities of selecting the plurality of paths.

In the procedure of extracting the plurality of paths, in a case where the electronic device is a solid-state imaging device, the charge generation position may be obtained from a charge generation distribution in a photoelectric conversion region.

In the procedure of extracting the plurality of paths, the charge readout position may be set in accordance with a position of a transfer electrode.

Furthermore, according to the present disclosure, there is provided a charge transport characteristic calculation device including:
a first calculation unit that calculates an electrostatic potential of an electronic device;
a first extraction unit that extracts a plurality of metastable points in an electrostatic potential field of the electronic device;
a second extraction unit that extracts a plurality of paths for transporting a charge from a charge generation position to a charge readout position of the electronic device via the plurality of metastable points in the electrostatic potential field;
a second calculation unit that calculates a physical quantity of the electrostatic potential field in each of the plurality of paths; and
a third calculation unit that calculates a charge transport characteristic from the charge generation position to the charge readout position on a basis of the physical quantity of the electrostatic potential field in each of the plurality of paths.

### BRIEF DESCRIPTION OF DRAWINGS

FIG. 1 is a view for describing a charge transport characteristic calculation method according to a first embodiment of the present disclosure.

FIG. 2 is a flowchart of the charge transport characteristic calculation method according to the first embodiment of the present disclosure.

FIG. 3A is a view for describing electrostatic potential calculation according to the first embodiment of the present disclosure.

FIG. 3B is a view for describing an initial state of extraction of metastable points according to the first embodiment of the present disclosure.

FIG. 3C is a view for describing a completion state of extraction of the metastable points according to the first embodiment of the present disclosure.

FIG. 3D is a view for describing extraction of main transport paths according to the first embodiment of the present disclosure.

FIG. 3E is a view for describing circuit model generation according to the first embodiment of the present disclosure.

FIG. 4A is a view for describing extraction of the main transport paths according to the first embodiment of the present disclosure.

FIG. 4B is a plan view of FIG. 4A as viewed from above.

FIG. 4C is a plan view illustrating a modification of extraction of the main transport paths.

FIG. 5 is a view illustrating a charge transport characteristic calculation method according to one comparative example.

FIG. 6 is a block view illustrating a configuration of a charge transport characteristic calculation device according to the first embodiment of the present disclosure.

FIG. 7 is a view illustrating an example of an electronic device to which the charge transport characteristic calculation method according to the first embodiment of the present disclosure can be applied.

FIG. 8A is a view for describing an initial state of extraction of metastable points according to a second embodiment of the present disclosure.

FIG. 8B is an enlarged view of valleys and meshes.

FIG. 8C is a view for describing a completion state of extraction of the metastable points according to the second embodiment of the present disclosure.

FIG. 9 is a view illustrating a circuit model according to a third embodiment of the present disclosure.

FIG. 10A is a view for describing charge transport characteristic calculation according to a fourth embodiment of the present disclosure.

FIG. 10B is a schematic view illustrating extraction of metastable points of a movement destination according to the fourth embodiment of the present disclosure.

FIG. 10C is a circular graph illustrating selection probabilities of the main transport paths.

FIG. 11 is a view illustrating extraction of metastable points according to a fifth embodiment of the present disclosure.

FIG. 12A is a view illustrating extraction of a charge generation position according to a sixth embodiment of the present disclosure.

FIG. 12B is a view illustrating a circuit model according to the sixth embodiment of the present disclosure.

FIG. 13 is a view illustrating an example of an electronic device to which a charge transport characteristic calculation method according to a seventh embodiment of the present disclosure can be applied.

FIG. 14 is a view for describing a metastable point extraction method according to the seventh embodiment of the present disclosure.

FIG. 15A is a view illustrating a first equipotential surface in a VG region.

FIG. 15B is a view illustrating a second equipotential surface in the VG region.

FIG. 16 is a view illustrating an example of an electronic device to which a charge transport characteristic calculation method according to an eighth embodiment of the present disclosure can be applied.

FIG. 17 is a view for describing a metastable point extraction method according to a ninth embodiment of the present disclosure.

FIG. 18A is a view illustrating a valley group according to a tenth embodiment of the present disclosure.

FIG. 18B is a view illustrating a method of combining metastable points according to the tenth embodiment of the present disclosure.

FIG. 19A is a first view illustrating a main transport path extraction method according to an eleventh embodiment of the present disclosure.

FIG. 19B is a second view illustrating the main transport path extraction method according to the eleventh embodiment of the present disclosure.

FIG. 20 is a view illustrating a main transport path extraction method according to a twelfth embodiment of the present disclosure.

FIG. 21 is a view illustrating an example of a schematic configuration of an endoscopic surgery system.

FIG. 22 is a block view illustrating an example of a functional configuration of a camera head and a camera control unit (CCU).

### MODE FOR CARRYING OUT THE INVENTION

Hereinafter, embodiments of a charge transport characteristic calculation method and a charge transport characteristic calculation device will be described with reference to the drawings. Hereinafter, the main components of the charge transport characteristic calculation method and the charge transport characteristic calculation device will be mainly described, but the charge transport characteristic calculation method and the charge transport characteristic calculation device may have components and functions that are not illustrated or described. The following description is not intended to exclude configuration parts and functions that are not illustrated or described.

### First Embodiment

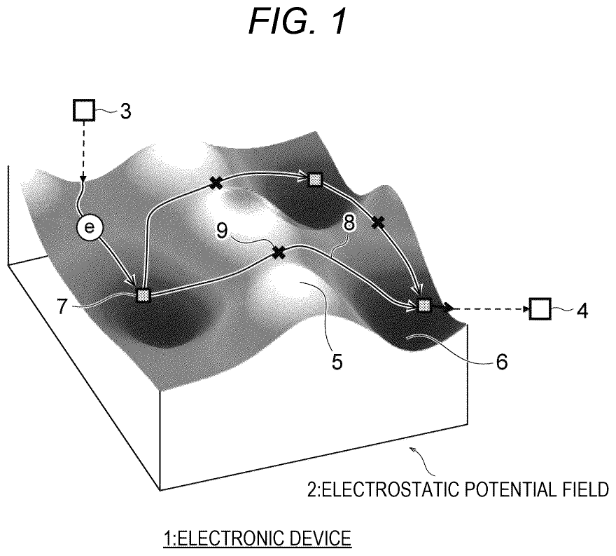

FIG. 1 is a view for describing a charge transport characteristic calculation method according to a first embodiment of the present disclosure. An electronic device 1 of FIG. 1 generates a charge (for example, an electron e) and transmits the generated charge to a device or the like at a subsequent stage, and includes an electrostatic potential field 2, a charge generation position 3, and a charge readout position 4. Note that in the present specification, an example in which the charge is an electron will be mainly described, but the charge for which a transport characteristic is calculated include a hole, a cation, or an anion.

A charge transport characteristic calculation method according to a first embodiment of the present disclosure calculates a transport characteristic of the electron e in the electrostatic potential field 2.

The electronic device 1 of FIG. 1 is a semiconductor device having the charge generation position 3 and the charge readout position 4 such as a photodiode. The electronic device 1 of FIG. 1 has the electrostatic potential field 2 arranged between the charge generation position 3 and the charge readout position 4. The electrostatic potential field 2 has a potential distribution in which a potential changes depending on a location. The electron e generated at the charge generation position 3 is transported through the electrostatic potential field 2 to the charge readout position 4. A transfer electrode for transferring the electron e is arranged in the vicinity of the charge readout position 4.

A path through which the electron e passes in the electrostatic potential field 2 is referred to as a transport path. A plurality of transport paths exists in the electrostatic potential field 2, and potential energy required when the electron e passes is different for each transport path. It is known that the electron e has a higher probability of passing through a transport path with low potential energy than a transport path with high potential energy.

The electrostatic potential field 2 has a plurality of mountains 5 each having a potential value higher than that of surroundings and a plurality of valleys 6 each having a potential value lower than that of surroundings. Each of the valleys 6 has a metastable point 7 at which the electron e can stably exist. The metastable point 7 may be a minimum point of the electrostatic potential field 2. In the electrostatic potential field 2, typically, a plurality of metastable points 7 exists.

Among the transport paths connecting two metastable points 7, a path that minimizes the potential energy required for passage is also called a minimum energy path (MEP) or a main transport path 8. The main transport path 8 is a transport path through which the electron e is most likely to pass. In the electrostatic potential field 2, there may exist a plurality of main transport paths 8 connecting the metastable points 7. Similarly, the main transport path 8 may exist between the charge generation position 3 and the metastable point 7 and between the metastable point 7 and the charge readout position 4.

Each of the plurality of main transport paths 8 has a barrier 9. The barrier 9 is an index representing difficulty of passing of the electron e, that is, a magnitude of a charge transfer obstacle in each of the plurality of main transport paths 8, and is also called a potential barrier. More specifically, the barrier 9 determines the potential energy required for the electron e to pass through the main transport path 8. A height of the barrier 9 is determined by a degree of potential change on the individual main transport path 8. The greater the potential change, the higher the barrier 9. As the main transport path 8 has a higher barrier 9, the electron e is unlikely to pass.

The charge transport characteristic calculation method according to the present embodiment is characterized in that the charge transport characteristic of the electrostatic potential field 2 is calculated by the plurality of metastable points 7, the plurality of main transport paths 8, and the barriers 9 without considering all the transport paths existing in the electrostatic potential field 2.

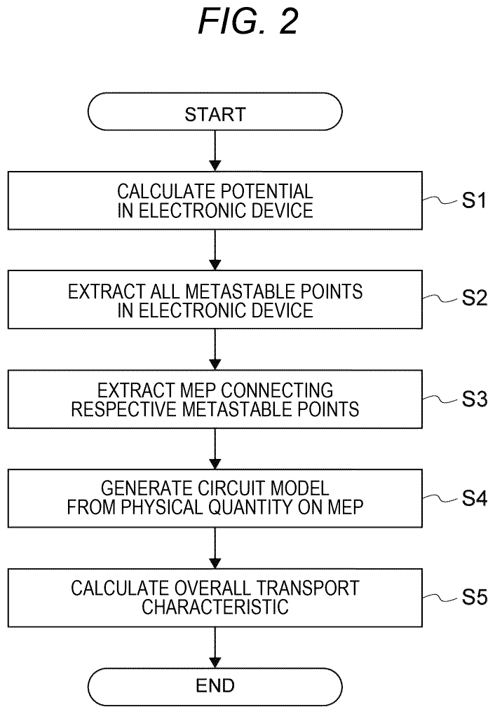

FIG. 2 is a flowchart of the charge transport characteristic calculation method according to the first embodiment of the present disclosure. The processing of the flowchart of FIG. 2 is executed by, for example, a charge transport characteristic calculation device as described later. First, an electrostatic potential in the electronic device 1 is calculated (step S1). The electrostatic potential can be calculated using a model equation of a target semiconductor device. In step S1, the electrostatic potential field 2 having a plurality of mountains 5 and a plurality of valleys 6 is generated using the calculated electrostatic potential.

Subsequently, a plurality of metastable points 7 is extracted in the electrostatic potential field 2 (step S2). For example, a gradient method is used to extract the metastable points 7 in step S2.

Subsequently, a plurality of paths for transporting an electron e from the charge generation position 3 to the charge readout position 4 of the electronic device 1 via the plurality of metastable points 7 in the electrostatic potential field 2 is extracted (step S3). More specifically, the charge generation position 3, the charge readout position 4, and the plurality of main transport paths 8 connecting the plurality of metastable points 7 are extracted. For the extraction of the main transport paths 8 in step S3, for example, a nudged elastic band (NEB) method is used.

Finally, a circuit model is generated on a basis of a physical quantity of the electrostatic potential field 2 in each of the plurality of main transport paths 8 (step S4). The physical quantity is, for example, the height of the barrier 9. From this circuit model, an overall charge transport characteristic of the electronic device 1, more specifically, the charge transport characteristic from the charge generation position 3 to the charge readout position 4 is calculated (step S5).

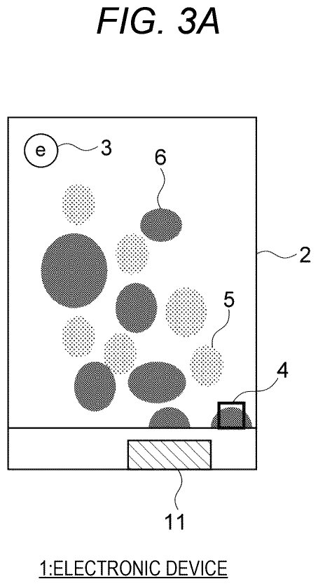

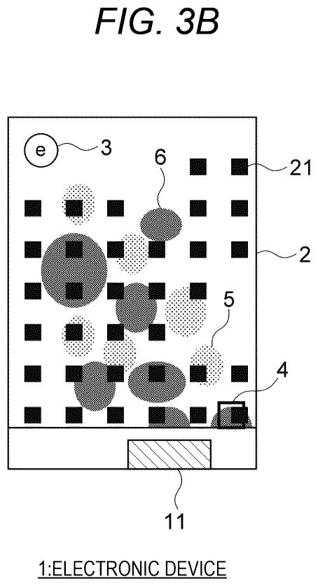

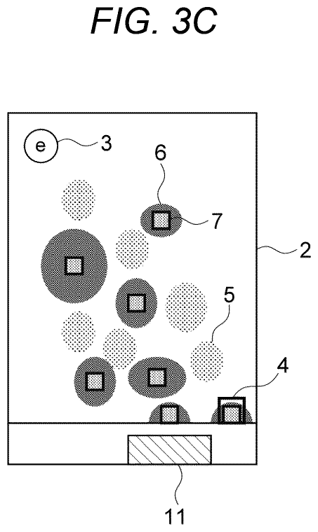

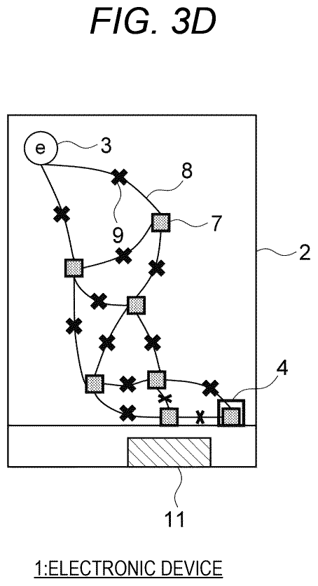

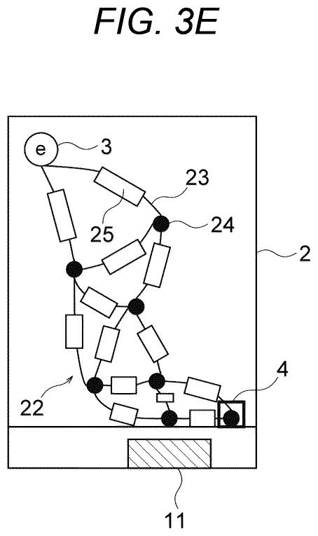

FIGS. 3A to 3E are views for describing the charge transport characteristic calculation method in FIG. 2. FIG. 3A is a view for describing step S1. The electronic device 1 in FIG. 3A includes a transfer electrode 11. The electronic device 1 generates the electron e at the charge generation position 3, and a voltage is applied to the transfer electrode 11, so that the electron e is readout from the charge readout position 4. Note that the charge readout position 4 is set in accordance with the position of the transfer electrode 11. By step S1, the electrostatic potential field 2 having the plurality of mountains 5 and valleys 6 is generated in the electronic device 1. In the example of FIG. 3A, the charge generation position 3 and the charge readout position 4 are arranged inside the electrostatic potential field 2.

FIG. 3B is a view for describing an initial state of step S2. As described above, in step S2, the metastable point 7 is extracted by, for example, a gradient method. As the initial state of the gradient method, a plurality of initial points (initial electrons) 21 is set in the electrostatic potential field 2. The plurality of initial points 21 is set at constant intervals in the electrostatic potential field 2, for example.

Although the number and arrangement location of the plurality of initial points 21 are arbitrary, since all the minimum points in the electrostatic potential field 2 are extracted on a basis of the electric fields at the plurality of initial points 21, a calculation accuracy of the gradient method changes according to the setting of the initial points 21, and in some cases, extraction omission or the like of the metastable point 7 may occur. In order to improve the calculation accuracy, it is desirable to set more initial points 21. FIG. 3B illustrates an example in which the plurality of initial points 21 is uniformly set in the entire electrostatic potential field 2. However, more initial points 21 may be set at locations where a large number of metastable points 7 are extracted.

In the gradient method in step S2, the plurality of initial points 21 moves little by little to a position having a smaller electrostatic potential according to a gradient of the electric field of the electrostatic potential field 2. The movement of the initial points 21 converges at a position (that is, the metastable point 7) that becomes a minimum point which is the valley of the electrostatic potential field. Such processing of obtaining the position where the movement of the virtually arranged initial points converges is also called optimization. FIG. 3C is a view for describing a state in which the optimization in step S2 is completed. As illustrated in FIG. 3C, the plurality of valleys 6 in the electrostatic potential field is extracted as metastable points 7, respectively.

FIG. 3D is a view for describing step S3. In step S3, the main transport paths 8 are extracted between the charge generation position 3 and the metastable point 7, between the metastable point 7 and the charge readout position 4, and between the two metastable points 7, respectively. Details of the extraction processing of the main transport path 8 will be described later.

In each of the plurality of main transport paths 8, the potential is not constant, and the potential changes in the middle of the path. The degree of potential change in the middle of the path is the barrier 9. In FIG. 3D, the barrier 9 of each main transport path 8 is denoted by “X”. The barrier 9 represents a magnitude of a charge transfer obstacle of the electrostatic potential field 2 in each of the plurality of main transport paths 8. The height of the barrier 9 differs for each of the plurality of main transport paths 8.

FIG. 3E is a view for describing steps S4 and S5. In step S4, for example, a circuit model 22 as illustrated in FIG. 3E is generated. The circuit model 22 has a plurality of wirings 23 corresponding to the plurality of main transport paths 8, a plurality of connection nodes 24 corresponding to the plurality of metastable points 7, and a plurality of resistors 25 corresponding to the barriers 9 of the plurality of main transport paths 8. Furthermore, the resistor 25 is arranged in each of the plurality of wirings 23. The resistor 25 has a resistance value corresponding to a physical quantity of the electrostatic potential field 2 in each of the plurality of main transport paths 8. More specifically, the resistor 25 has a resistance value corresponding to the height of the barrier 9 of the corresponding main transport path 8. In this way, by expressing the height of the barrier 9 of each main transport path 8 by the resistance value of the resistor 25, it is easy to take the barrier 9 of each main transport path 8 into consideration.

In step S5, a combined resistance value obtained by combining the resistance values of each of the plurality of resistors 25 in the circuit model 22 is calculated. This combined resistance value represents a magnitude of the charge transfer obstacle from the charge generation position 3 to the charge readout position 4 of the electronic device 1. The overall charge transport characteristic of the electronic device 1 is calculated by using the circuit model 22 and the calculated combined resistance value.

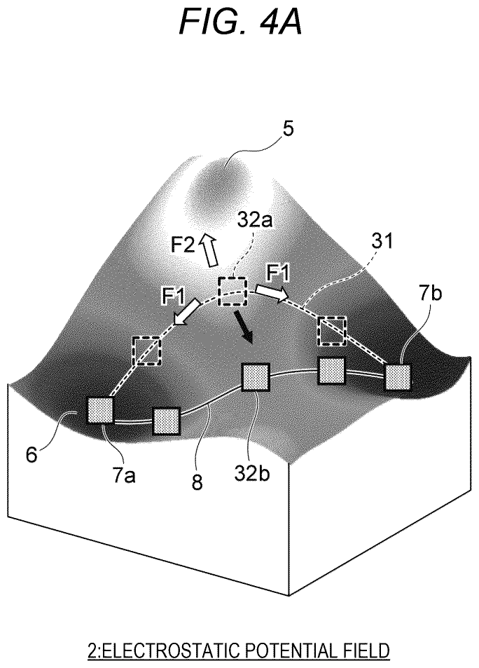

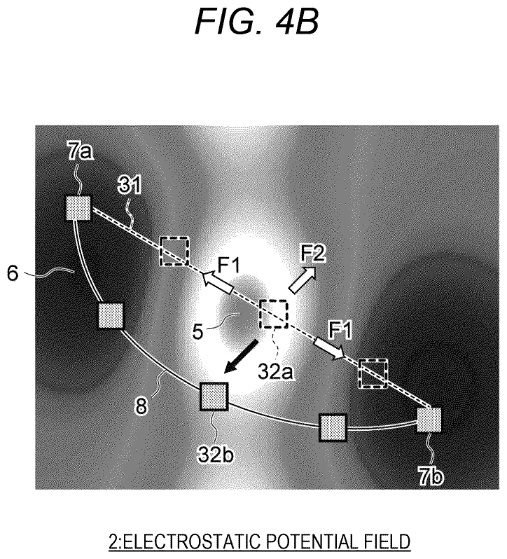

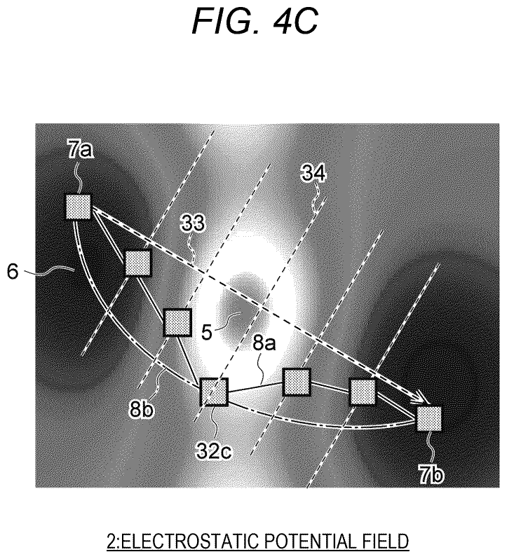

FIGS. 4A and 4B are views for more specifically describing the processing of step S3 in FIG. 2. FIG. 4A is a view for describing extraction of the main transport paths 8 according to the first embodiment of the present disclosure. FIG. 4B is a plan view of FIG. 4A as viewed from above. FIGS. 4A and 4B illustrate an example in which the main transport path 8 between a metastable point 7a as a start point and a metastable point 7b as an end point is extracted by the NEB method.

In the NEB method, as illustrated in FIGS. 4A and 4B, first, an initial transport path 31 connecting the metastable point 7a and the metastable point 7b is set.

The initial transport path 31 can be represented by a path connecting the metastable points 7a and 7b by a straight line, for example, as illustrated in FIG. 4B. The initial transport path 31 has a plurality of saddle points 32a, and the saddle points 32a are set on the transport path 31, for example, at equal intervals.

The NEB method assumes a spring force Fl acting on adjacent saddle points 32a and a spring force F2 acting in a direction perpendicular to the spring force F1. The NEB method extracts saddle points 32b at which the spring force F1 and the spring force F2 are minimized. By the NEB method, transport paths connecting the plurality of saddle points 32b can be extracted as the main transport paths 8.

Furthermore, as a modification, a drag method may be used to extract the main transport paths 8. FIG. 4C is a plan view for describing extraction of the main transport paths 8 by the drag method. In the drag method, a plurality of surfaces 34 perpendicular to a straight line 33 connecting the metastable point 7a and the metastable point 7b is arranged. On each of these surfaces 34, a saddle point 32c at which the potential is minimized is extracted. In the drag method, transport paths connecting the plurality of extracted saddle points 32c are extracted as the main transport paths 8a.

The drag method is characterized by a simpler algorithm and a smaller calculation amount than the NEB method. On the other hand, the drag method merely obtains each of the saddle points 32c where the electrostatic potential is minimum, and does not consider the gradient or the like of the electric field between the adjacent saddle points, and thus has a problem of low extraction accuracy. Therefore, there is a possibility that the main transport path 8a different from a true main transport path 8b is extracted, and there is a possibility that the barrier between the metastable point 7a and the metastable point 7b cannot be accurately extracted.

As described with reference to FIGS. 4A to 4C, in step S3 of FIG. 2, a plurality of main transport paths 8 is extracted by preferentially selecting a path having a smaller electrostatic potential. For the extraction of the plurality of main transport paths 8, a string method, a conjugate peak refinement (CPR) method, a Ridge method, a Dewar, Healy, and Stewart (DHS) method, or the like may be used in addition to the NEB method and the drag method.

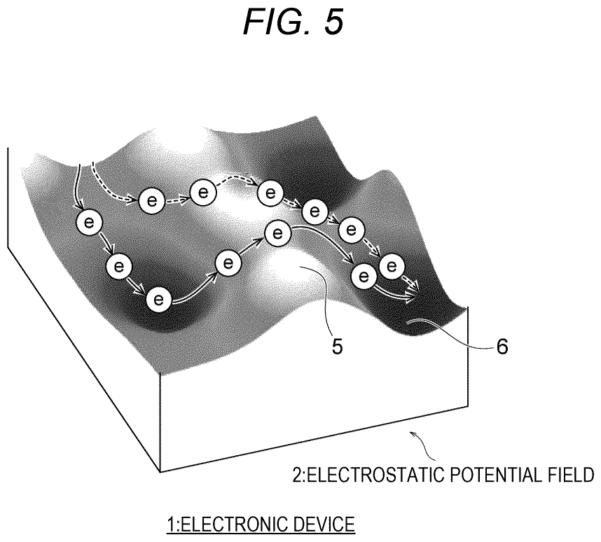

FIG. 5 is a view illustrating a charge transport characteristic calculation method according to one comparative example. The charge transport characteristic calculation method in FIG. 5 updates the state of the electrostatic potential field 2 and the positions of the plurality of electrons e at minute time intervals, and analyzes the movement of the plurality of electrons e in the entire region of the electrostatic potential field 2 in detail.

In the charge transport characteristic calculation method according to one comparative example, transport paths other than the main transport path in the electrostatic potential field 2 are also calculated at minute time intervals, and thus the calculation amount increases and unnecessary calculation also increases.

On the other hand, the charge transport characteristic calculation method according to the first embodiment of the present disclosure is efficient with a small calculation amount because analysis is performed only for the main transport path 8.

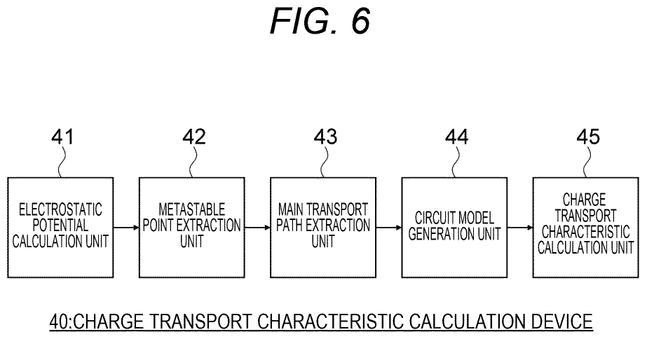

FIG. 6 is a block view illustrating a configuration of a charge transport characteristic calculation device 40 according to the first embodiment of the present disclosure. The charge transport characteristic calculation device 40 can be implemented by hardware such as a semiconductor chip. Alternatively, the charge transport characteristic calculation device 40 can be implemented by a computer executing software (program).

The charge transport characteristic calculation device 40 includes an electrostatic potential calculation unit (first calculation unit) 41, a metastable point extraction unit (first extraction unit) 42, a main transport path extraction unit (second extraction unit) 43, a circuit model generation unit (second calculation unit) 44, and a charge transport characteristic calculation unit (third calculation unit) 45.

The electrostatic potential calculation unit 41 calculates the electrostatic potential of the electronic device 1 and generates the electrostatic potential field 2. The metastable point extraction unit 42 extracts a plurality of metastable points 7 in the electrostatic potential field 2. The main transport path extraction unit 43 extracts the charge generation position 3, the charge readout position 4, and the plurality of main transport paths 8 connecting the plurality of metastable points 7. The circuit model generation unit 44 generates the circuit model 22 on a basis of the physical quantity of the electrostatic potential field 2 in each of the plurality of main transport paths 8. The charge transport characteristic calculation unit 45 calculates the overall charge transport characteristic of the electronic device 1 from the circuit model 22.

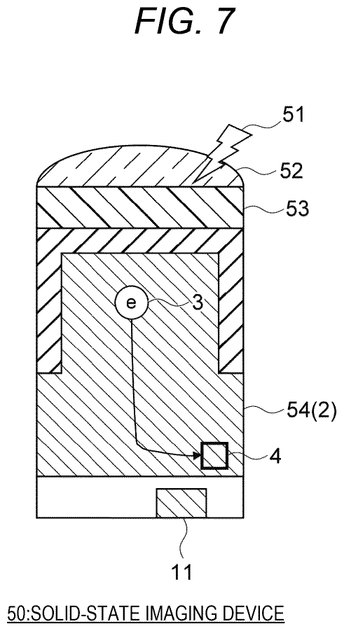

FIG. 7 is a view illustrating an example of the electronic device 1 to which the charge transport characteristic calculation method according to the first embodiment of the present disclosure can be applied. The electronic device in FIG. 7 is a solid-state imaging device 50. The solid-state imaging device 50 illustrated in FIG. 7 can calculate a transport characteristic of a charge (for example, the electron e) by the charge transport characteristic calculation method according to the first embodiment of the present disclosure.

Hereinafter, an example in which the solid-state imaging device 50 transfers the electron e generated by photoelectric conversion will be described, but the present disclosure is also applicable to a case where holes generated by photoelectric conversion are transferred.

In the solid-state imaging device 50, the electron e generated by photoelectric conversion is transferred to a pixel circuit via the transfer electrode, and a pixel signal is generated. Image data is generated by the pixel signal of each pixel. The solid-state imaging device 50 includes a plurality of pixels arranged in a binary direction, and each pixel includes a lens 52, a color filter 53, a photoelectric conversion region 54, and a transfer electrode 11. FIG. 7 illustrates a cross-sectional structure for one pixel.

The lens 52 condenses incident light 51 to the solid-state imaging device 50. The color filter 53 separates the incident light 51 for each wavelength. The photoelectric conversion region 54 receives the incident light 51 via the lens 52 and the color filter 53. The photoelectric conversion region 54 is, for example, a photodiode, and generates an electron e corresponding to an amount of incident light by the photoelectric conversion. In the photoelectric conversion region 54, a concentration of impurity ions varies depending on the location, and the electrostatic potential field 2 is formed. The electron e generated by the photoelectric conversion passes through the electrostatic potential field 2 and is transferred to the transfer electrode 11. The transfer electrode 11 is, for example, a gate electrode.

The charge transport characteristic calculation method and the charge transport characteristic calculation device according to the first embodiment can analyze a transport path of the electron e in the photoelectric conversion region 54 of the solid-state imaging device 50 in FIG. 7. In this case, a portion where the electron e is generated by the photoelectric conversion in the photoelectric conversion region 54 is the charge generation position 3, and a portion where the electron e is transferred from the photoelectric conversion region 54 to the transfer electrode is the charge readout position 4.

According to the present embodiment, since the transport path of the electron in the photoelectric conversion region 54 can be accurately analyzed in a short time, the design of distribution of impurity ions in the photoelectric conversion region 54, an arrangement location of a light shielding member, an arrangement location of the transfer electrode, and the like can be optimized.

As described above, in the first embodiment of the present disclosure, instead of analyzing all the paths connecting the mountains and the valleys of the potential in the electrostatic potential field, only the main transport path is extracted, and the charge transport characteristic from the charge generation position to the charge readout position is calculated on a basis of the barrier of each main transport path. With this arrangement, according to the first embodiment, the charge transport characteristic can be accurately calculated with a smaller calculation amount than that of one comparative example of FIG. 5. Furthermore, according to the first embodiment, since an electrostatic potential field having a complicated gradient of an electric field can be simplified as a circuit model, analysis such as extraction of a region that becomes a bottleneck of charge transport is easy. With this arrangement, a performance and evaluation of the electronic device can be efficiently and accurately performed, the design of the electronic device can be made efficient, and the quality of the electronic device can be improved.

### Second Embodiment

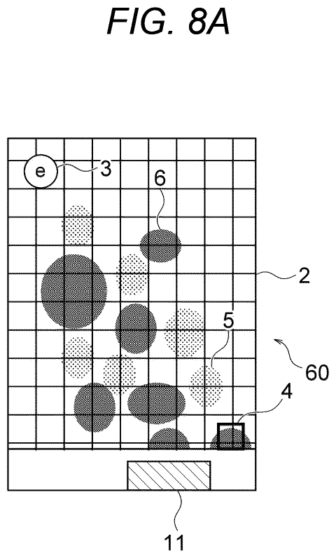

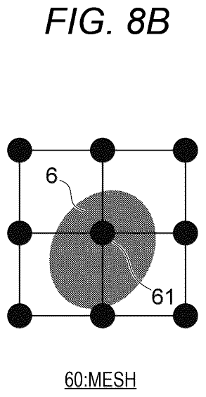

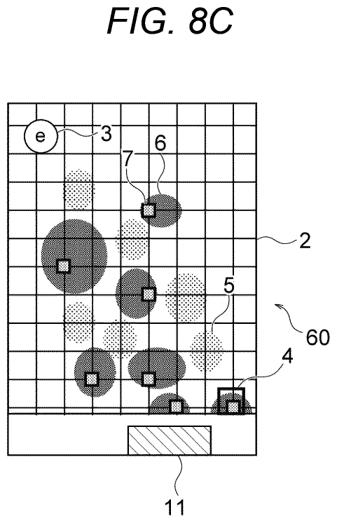

Various modifications are conceivable for the charge transport characteristic calculation method according to the present disclosure. For example, a search method may be used to extract the metastable point 7 in step S2 of FIG. 2. FIGS. 8A to 8C are views for describing extraction of the metastable point 7 according to a second embodiment of the present disclosure. FIGS. 8A to 8C correspond to FIGS. 3B and 3C described in the first embodiment of the present disclosure.

FIG. 8A is a view illustrating an initial state of the search method. In the search method, the entire electrostatic potential field 2 is mesh-divided by a mesh 60. FIG. 8B is an enlarged view of the valley 6 and the mesh 60. The mesh 60 has lattice points 61 arranged at contacts between the mesh-divided elements. Note that in the present specification, an example in which the electrostatic potential field 2 is mesh-divided into a plurality of quadrangular elements is illustrated, but the present disclosure is not limited thereto. For example, the electrostatic potential field 2 may be mesh-divided into a plurality of triangular elements, or may be mesh-divided in a form in which quadrangles and triangles are mixed.

At the lattice point 61, an electric field of the electrostatic potential field 2 at each position is set. In the search method, the lattice point 61 is moved to search for a value in which the electric field is zero and the differential value of the electric field is positive, and the position found by the search is set as the metastable point 7. FIG. 8C is a view illustrating a completion state of the search method. As illustrated in FIG. 8C, the plurality of metastable points 7 can be extracted by the search method similarly to FIG. 3C.

In the search method, since the entire electrostatic potential field 2 is calculated, extraction omission of the metastable point 7 is unlikely to occur. On the other hand, the calculation accuracy and the calculation amount change depending on a mesh width. When the mesh width is smaller, the calculation accuracy is improved, but the calculation amount increases. Therefore, in the search method, it is desirable to set the mesh width according to the required calculation accuracy.

### Third Embodiment

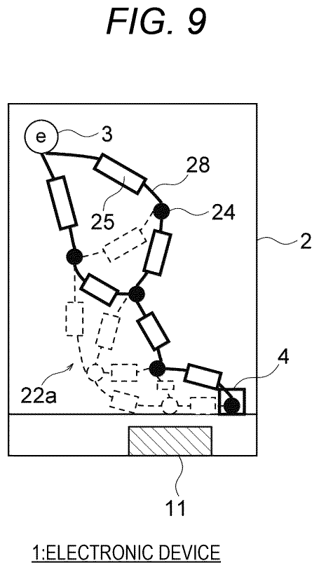

In the calculation of the circuit model 22 in steps S4 and S5 of FIG. 2, calculation of some circuits may be omitted. FIG. 9 is a view illustrating a circuit model 22a according to a third embodiment of the present disclosure. The circuit model 22a is obtained by extracting the resistors 25 having a resistance value greater than or equal to a predetermined threshold from among the resistors 25 of the circuit model 22 and removing the wirings 23 having the extracted resistors 25.

The third embodiment of the present disclosure calculates a combined resistance value of the circuit model 22a described above. That is, in the charge transport characteristic calculation according to the third embodiment of the present disclosure, the combined resistance value is calculated in consideration of only the wirings having the resistance value less than the predetermined threshold without considering the wirings having the resistance value greater than or equal to the predetermined threshold.

As described above, according to the third embodiment, since the wirings 23 having the resistors 25 having the resistance value greater than or equal to the predetermined threshold are ignored, the main transport paths 8 having a high barrier and through which the electron e passes with low possibility are excluded from the calculation target. With this arrangement, unnecessary calculation can be omitted, and charge transport characteristic calculation considering only main paths through which the electron e passes with a high probability can be performed.

The charge transport characteristic calculation according to the third embodiment of the present disclosure can further reduce the calculation amount as compared with the charge transport characteristic calculation according to the first embodiment. Furthermore, in the third embodiment of the present disclosure, since only the main transport paths 8 through which the electron e passes with a higher probability are extracted to calculate the charge transport characteristic, the calculation accuracy can be maintained. The third embodiment of the present disclosure can be applied to both the first and second embodiments.

### Fourth Embodiment

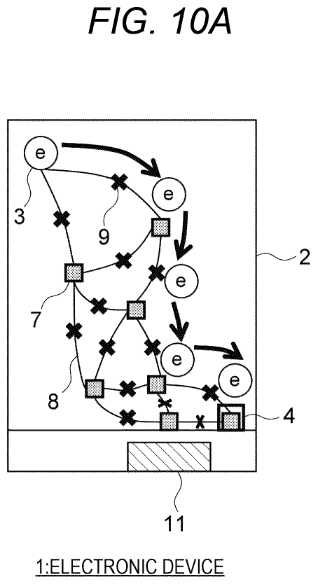

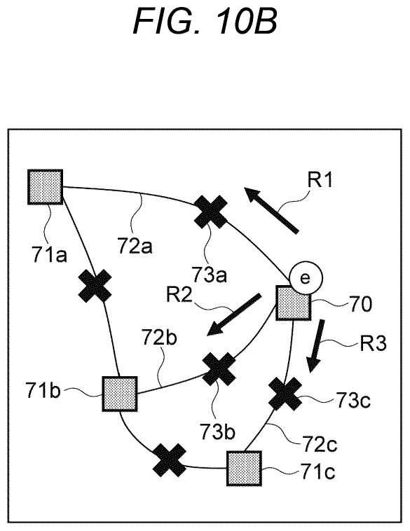

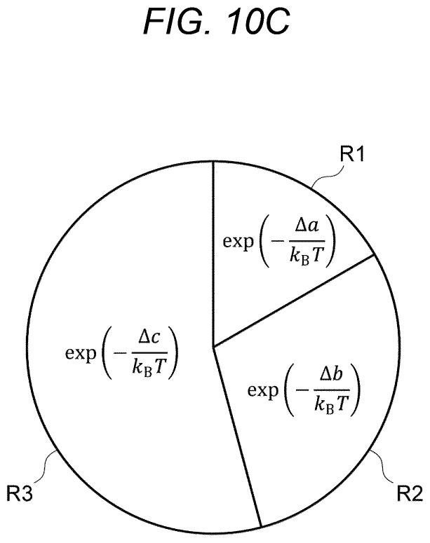

A Monte Carlo method may be used to calculation of the overall charge transport characteristic of the electronic device 1 in steps S4 and S5 of FIG. 2. FIG. 10A is a view for describing charge transport characteristic calculation according to a fourth embodiment of the present disclosure. In the Monte Carlo method, as illustrated in FIG. 10A, in the process in which the electron e moves from the charge generation position 3 to the charge readout position 4, every time the electron e reaches one metastable point 7, the main transport path 8 through which the electron e passes next is selected.

FIG. 10B is a schematic view illustrating extraction of the metastable point 7 of a movement destination according to the fourth embodiment of the present disclosure. FIG. 10B illustrates an example in which the electron e exists at one metastable point 70.

In the example of FIG. 10B, metastable points 71a, 71b, and 71c are arranged adjacent to the metastable point 70. Main transport paths 72a, 72b, and 72c extend from the metastable point 70 with respect to the metastable points 71a, 71b, and 71c, respectively. Furthermore, the main transport paths 72a, 72b, and 72c have barriers 73a, 73b, and 73c, respectively.

The electron e existing at the metastable point 70 selects any one of the main transport paths 72a, 72b, and 72c as the main transport path 8 to be passed next. The probabilities at which the main transport paths 72a, 72b, and 72c are selected are represented by probabilities R1, R2, and R3, respectively.

FIG. 10C is a circular graph illustrating the selection probabilities of the main transport paths 72a, 72b, and 72c. Assuming that barrier heights of the barriers 73a, 73b, and 73c are Aa, Ab, and Ac, respectively, the probabilities R1, R2, and R3 are expressed by exp(−Δa/k_{B}T), exp(−Δb/k_{B}T), and exp(−Δc/k_{B}T), respectively, using predetermined variables k_{B} and T. That is, the higher the barrier height, the lower the probability of being selected as the main transport path 8. Furthermore, a sum of the probabilities R1, R2, and R3 is 100%. FIGS. 10B and 10C illustrate an example in which the three main transport paths 8 extend from the metastable point 70, but the selection probability of the main transport path 8 can be similarly calculated in a case where the number of the main transport paths 8 is two or less or four or more.

In the fourth embodiment of the present disclosure, the charge transport characteristic is calculated on a basis of a value obtained by multiplying the physical quantities of the plurality of main transport paths 8 by the probabilities of selecting the plurality of main transport paths 8. More specifically, in the fourth embodiment of the present disclosure, every time a new metastable point 7 is extracted, the processing of calculating the selection probabilities for all the main transport paths 8 connected to the new metastable point 7 and extracting the next metastable point 7 is repeatedly performed. With this arrangement, the optimum metastable point 7 can be extracted with a small calculation amount without omission. Furthermore, in the fourth embodiment of the present disclosure, since transient calculation is performed, it is possible to analyze a state in the middle of transporting the electron e. Furthermore, according to the fourth embodiment of the present disclosure, the time required for the electron e to be transported and the like may be calculated.

In the fourth embodiment of the present disclosure, as compared with one comparative example of FIG. 5, it is not necessary to calculate for all the transport paths, and it is only necessary to calculate for the main transport path 8. Furthermore, while one comparative example of FIG. 5 requires calculations at minute time intervals, the fourth embodiment of the present disclosure requires calculations each time the electron e reaches the metastable point 7, and thus the calculation amount is smaller than that in one comparative example of FIG. 5. The fourth embodiment of the present disclosure can be applied to both the first and second embodiments.

### Fifth Embodiment

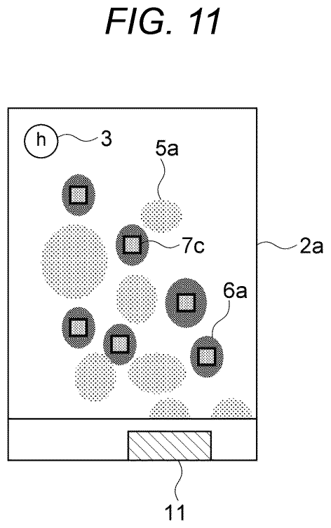

In the first to fourth embodiments of the present disclosure, an example of calculating a transport characteristic of a negative charge (that is, the electron e) has been mainly described, but the charge transport characteristic calculation of the present disclosure is also applicable to a positive charge (for example, hole h). In this case, in step S2 of FIG. 2, the minimum point after sign inversion of the electrostatic potential is extracted as the metastable point 7. FIG. 11 is a view illustrating extraction of a metastable point 7c according to a fifth embodiment of the present disclosure.

In an electrostatic potential field 2a in FIG. 11, the electrostatic potential is code-inverted. The electrostatic potential field 2a has a plurality of potential mountains 5a corresponding to the valleys 6 in FIG. 3A and a plurality of potential valleys 6a corresponding to the mountains 5. The metastable points 7c are extracted from the valleys 6a, respectively.

Either the gradient method in FIGS. 3B and 3C or the search method in FIGS. 8A to 8C may be used to extract the metastable points 7c. In steps S3 and S4 of FIG. 2, similarly to the first embodiment, the main transport paths 8 are extracted for the metastable points 7c, and the circuit model 22 is generated.

As described above, in the fifth embodiment of the present disclosure, the minimum points after sign inversion of the electrostatic potential are extracted as the metastable points 7c, so that the charge transport characteristic calculation according to the first to fourth embodiments of the present disclosure can be applied to the positive charge.

### Sixth Embodiment

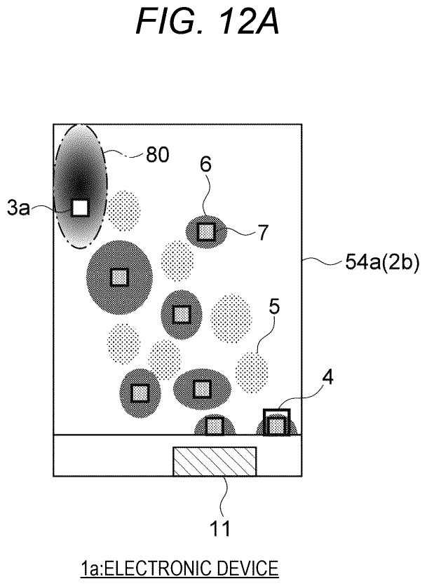

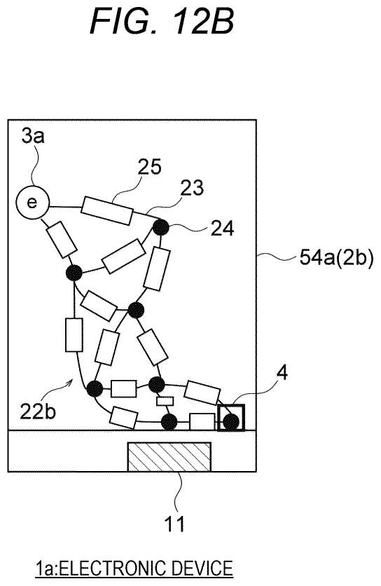

The charge transport characteristic calculation method and the charge transport characteristic calculation device according to the first to fifth embodiments can be applied to, for example, the electronic device that generates the charge by photoelectric conversion such as the solid-state imaging device 50 in FIG. 7. FIG. 12A is a view illustrating an electrostatic potential field of an electronic device that is a calculation target of a charge transport characteristic calculation method and a charge transport characteristic calculation device according to a sixth embodiment of the present disclosure. An electronic device la in FIG. 12A has a photoelectric conversion region 54a in which an electrostatic potential field 2b is generated.

The electrostatic potential field 2b has a charge generation distribution 80. The charge generation distribution 80 is a distribution indicating a position where an electron is generated by photoelectric conversion. In the sixth embodiment, a position where an electron e is generated at a highest frequency in the charge generation distribution 80 is defined as a charge generation position 3a.

FIG. 12B is a view illustrating a circuit model 22b generated by the charge transport characteristic calculation method and the charge transport characteristic calculation device according to the sixth embodiment of the present disclosure. The circuit model 22b starts from the charge generation position 3a obtained from the charge generation distribution 80 in FIG. 12A. Note that the circuit model 22b can be generated by a method similar to that of the first to third embodiments. Furthermore, in the charge transport characteristic calculation according to the sixth embodiment of the present disclosure, a Monte Carlo method similar to that of the fourth embodiment may be used.

Pairs of electrons and holes are generated for each location where photoelectric conversion is performed. For this reason, in the sixth embodiment, similarly to the fifth embodiment, it is also possible to calculate the transport characteristic of the holes with the location where the most holes are generated as the charge generation position 3a.

As described above, in the sixth embodiment of the present disclosure, the charge transport characteristic can be calculated with the charge generation position 3a serving as the start point of the circuit model 22b as a start point using the charge generation distribution 80 of the charge generated by photoelectric conversion.

Therefore, it is possible to accurately analyze the movement path of the charge in the photoelectric conversion region of the solid-state imaging device, to use the movement path for designing the solid-state imaging device, and to improve the quality of the solid-state imaging device.

### Seventh Embodiment

A method other than the gradient method and the search method may be used to extract the metastable point 7 in step S2 of FIG. 2. In a charge transport characteristic calculation method according to a seventh embodiment of the present disclosure, a method of scanning an equipotential surface having a same potential and extracting the metastable point 7 (also referred to as a potential scan method) is used.

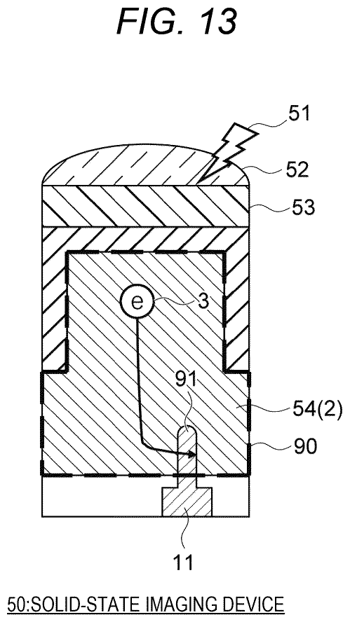

FIG. 13 is a view illustrating an example of the electronic device 1 (solid-state imaging device 50) to which the charge transport characteristic calculation method according to the seventh embodiment of the present disclosure can be applied. In the solid-state imaging device 50 illustrated in FIG. 13, a scan region (space region) 90 for scanning the equipotential surface is set in the electrostatic potential field 2. In the example of FIG. 13, the scan region 90 is set in the entire region of the electrostatic potential field 2.

Furthermore, FIG. 13 illustrates a vertical gate (VG) region 91 extending from the transfer electrode 11 to the electrostatic potential field 2.

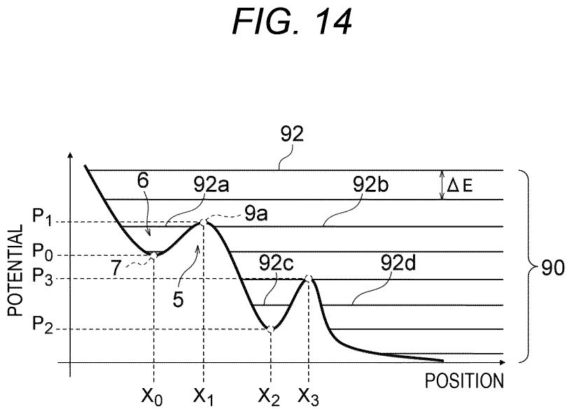

FIG. 14 is a view illustrating a method of extracting the metastable point 7 according to the seventh embodiment of the present disclosure. FIG. 14 illustrates a potential distribution in a one-dimensional direction of the scan region 90. A horizontal axis in FIG. 14 indicates a coordinate position in the one-dimensional direction in the scan region 90, and a vertical axis indicates a magnitude of the potential. In practice, the potential distribution of the scan region 90 spreads in a two-dimensional direction, but FIG. 14 illustrates the potential distribution in the one-dimensional direction for the sake of simplicity. Hereinafter, an uppermost surface of the potential distribution spreading in the two-dimensional direction is referred to as a potential curved surface.

As illustrated in FIG. 14, the potential curved surface has a plurality of mountains 5 and a plurality of valleys 6. In the example of FIG. 14, the potential curved surface has minimum points (that is, the metastable points 7) at positions X₀ and X₂ and maximum points (that is, peak positions of the barriers 9a) at positions X₁ and X₃. The potentials at the positions X₀, X₁, X₂, and X₃ are P₀, P₁, P₂, and P₃, respectively. Hereinafter, in the present specification, a peak position of the barrier 9a is also simply referred to as a position of the barrier 9a.

In the method of extracting the metastable point 7 according to the seventh embodiment of the present disclosure, the equipotential surface 92 having a same potential is moved while changing the potential, and a portion where at least a part of the equipotential surface 92 disappears is extracted as the metastable point 7.

The equipotential surface 92 is a surface region having the same potential arranged in the space region above the potential curved surface. When the equipotential surface 92 is moved while changing the potential, the equipotential surface 92 intersects the potential curved surface. With this arrangement, holes are formed in the equipotential surface 92 according to the size of the intersection region with the potential curved surface. Since the potential curved surface has the plurality of mountains 5 and the plurality of valleys 6 as described above, the number and area of the above-described holes increase as the potential of the equipotential surface 92 is lowered, and the equipotential surface 92 eventually partially disappears. In the equipotential surface 92, the partially disappeared portion is a bottom of the valley 6, that is, the metastable point 7.

In the example of FIG. 14, when the equipotential surface 92 is gradually made smaller, the equipotential surface 92 first intersects the potential curved surface at the position X₁, so that the peak position (barrier 9a) of the mountain 5 is extracted at the position X₁. Furthermore, as the equipotential surface 92 is made smaller, a part of the equipotential surface 92 (equipotential surface 92a) disappears at the position X₀. With this arrangement, the position X₀ is extracted as the bottom (metastable point 7) of the valley 6.

Furthermore, as the equipotential surface 92 is made smaller, the barrier 9a is extracted at the position X₃ on a remaining part (equipotential surface 92b) of the equipotential surface 92. Furthermore, as the equipotential surface 92 is made smaller, a part of the equipotential surface 92 (equipotential surface 92c) disappears at the position X₂. With this arrangement, the position X₂ is extracted as the metastable point 7.

Similarly, also in a remaining part of the equipotential surface 92 (equipotential surface 92d), the equipotential surface 92 is gradually made smaller, and a position where at least a part of the equipotential surface 92 disappears is searched for to extract the metastable point 7.

In the potential scan method, for example, every time the equipotential surface 92 is made smaller by a constant potential interval ΔE, the equipotential surface 92 is scanned to determine whether or not at least a part of the equipotential surface 92 has disappeared.

The metastable point 7 may not necessarily be extracted on a basis of the disappearance position of the equipotential surface 92. For example, in a case where the equipotential surface 92 is scanned and an area of at least a part of the equipotential surface 92 becomes sufficiently small (for example, it is equal to or less than a predetermined threshold), the metastable point 7 may be extracted assuming that the part has disappeared. Alternatively, the center of gravity or the like of at least a part of the equipotential surface 92 having a sufficiently small area may be extracted as the metastable point 7.

In the extraction method of FIG. 14, not only the metastable point 7 but also the height of the barrier 9a indicating the magnitude of the charge transfer obstacle and the peak position of the barrier 9a can be extracted simultaneously. For example, the barrier 9a can be extracted from the position where the equipotential surface 92 disappears and the peak position of the mountain 5 around the position.

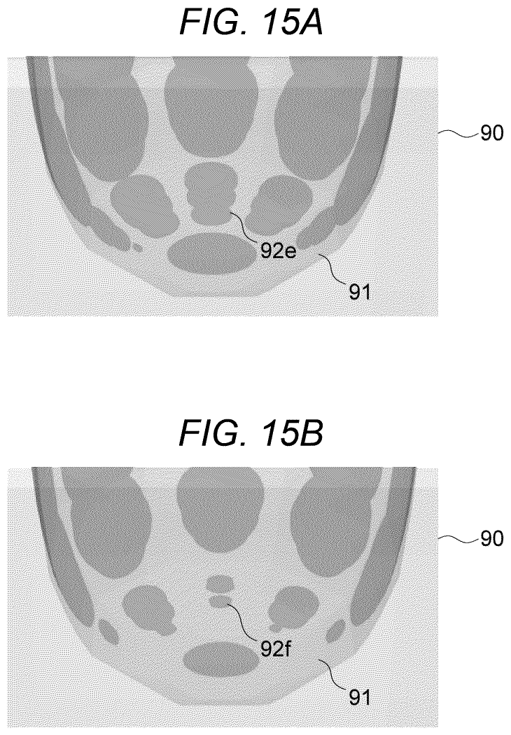

FIG. 15A is a view illustrating an equipotential surface 92e in a VG region 91. FIG. 15B is a view illustrating an equipotential surface 92f having a potential lower than that in FIG. 15A. As illustrated in FIGS. 15A and 15B, the area of the equipotential surface 92 becomes smaller by making the potential of the equipotential surface 92 smaller, and the position of the metastable point 7 is extracted from a portion where a part thereof disappears.

As described above, in the method of extracting the metastable point 7 according to the seventh embodiment of the present disclosure, the equipotential surface 92 is scanned while being gradually made smaller from a side where the potential is high (upper surface side of the potential). Note that the scanning of the equipotential surface 92 may be performed from a side where the potential is low in the scan region 90 (lower surface side of the potential). In this case, in a case where the equipotential surface 92 is generated from a portion where the equipotential surface 92 disappears, the portion may be extracted as the metastable point 7.

As described above, in the method of extracting the metastable point 7 according to the seventh embodiment of the present disclosure, the metastable point 7 is extracted by the potential scan method. The potential scan method can extract the metastable point 7 from a static potential in the electrostatic potential field 2, and therefore requires low calculation cost.

Specifically, as compared with the gradient method according to the first embodiment, the potential scan method does not need to calculate the movement of a large number of initial points 21, and therefore requires low calculation cost. Furthermore, the potential scan method is easier to perform calculation processing at the interface of the electrostatic potential field 2 than the search method (also referred to as a full mesh search method) according to the second embodiment, and therefore requires low calculation cost.

Furthermore, the potential scan method has characteristics of low parameter dependency and high extraction accuracy. The parameter is, for example, the potential interval 4E or the like when the equipotential surface 92 is scanned. As compared with the gradient method according to the first embodiment, the potential scan method has no possibility that extraction omission of the metastable point 7 occurs due to the initial arrangement of the initial points 21. Furthermore, as compared with the search method according to the second embodiment, there is no problem that the accuracy is significantly reduced or the calculation cost is significantly increased depending on the size of the mesh width. Furthermore, as compared with the search method according to the second embodiment, there is no possibility that the artificial valley 6 derived from the mesh is extracted, and the extraction speed and the extraction accuracy of the metastable point 7 can be improved.

In the potential scan method, the scan frequency of the equipotential surface 92 varies according to the potential interval ΔE. In the potential scan method, even if the scan frequency decreases, if the equipotential surface 92 of the valley can be extracted at least once, the metastable point 7 can be extracted from the extracted equipotential surface 92, so that extraction omission of the metastable point 7 is unlikely to occur as compared with the gradient method and the search method described above.

The charge transport characteristic calculation method according to any one of the third to sixth embodiments can be applied to the seventh embodiment of the present disclosure.

### Eighth Embodiment

In the seventh embodiment described above, the entire region of the electrostatic potential field 2 is set as the scan region 90, but a part of the electrostatic potential field 2, more specifically, a predetermined space region in which the charge generated in the electronic device 1 can be moved may be set as the scan region 90.

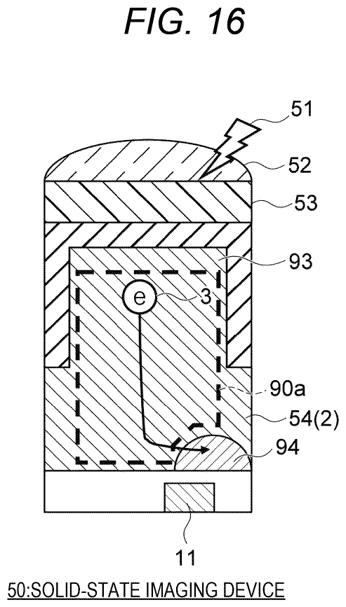

FIG. 16 is a view illustrating an example of the electronic device 1 to which a charge transport characteristic calculation method according to an eighth embodiment of the present disclosure can be applied. In the example of FIG. 16, for example, a scan region (space region) 90a is set in a region excluding a P-Well region 93 and a floating diffusion (FD) diffusion layer 94 in the electrostatic potential field 2.

Since the P-Well region 93 has a high potential and does not become a transfer path of the electron e, an influence on a transport characteristic of the electron e is small. Since the FD diffusion layer 94 is an end point of the transfer path of the electrons e, influence on the transport characteristic is small. Therefore, the scan region 90a in the eighth embodiment is set to a region obtained by excluding a region having a small influence on the transport characteristic as described above from the electrostatic potential field 2.

By limiting the range of the scan region 90a from which the equipotential surface 92 is extracted to a part of the electrostatic potential field 2, the calculation amount can be reduced, and the extraction of the metastable point 7 can be made faster.

### Ninth Embodiment

In the above-described eighth embodiment, the extraction of the metastable point 7 is made faster by limiting the range of the scan region 90a in the electrostatic potential field 2. On the other hand, a ninth embodiment of the present disclosure is characterized in that the extraction of the metastable point 7 is made faster by limiting a potential range from which the equipotential surface 92 is extracted.

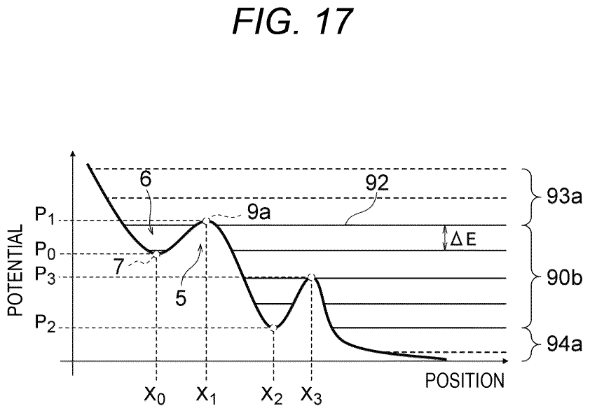

FIG. 17 is a view illustrating a method of extracting the metastable point 7 according to the ninth embodiment of the present disclosure. In FIG. 17, the potential that can be taken by the electronic device 1 is divided into three potential ranges 90b, 93a, and 94a.

The potential range 93a is a potential range of the P-Well region 93. The potential range 94a is a potential range of the FD diffusion layer 94. Since the potential ranges 93a and 94a do not affect the transport path of the electron e, in the present embodiment, the potential ranges 93a and 94a are omitted, and the equipotential surface 92 is extracted within the potential range 90b. With this arrangement, the extraction of the metastable point 7 can be made faster.

As illustrated in FIG. 17, the extraction of the metastable point 7 can be made faster by limiting the potential range from which the equipotential surface 92 is extracted to a range that affects the transport.

### Tenth Embodiment

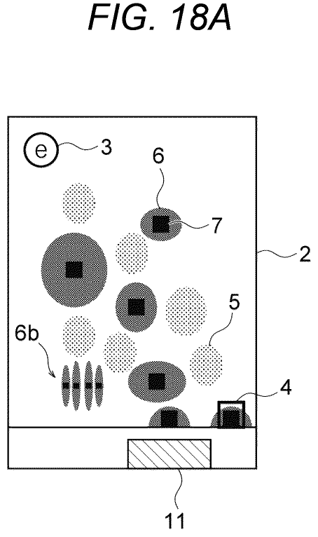

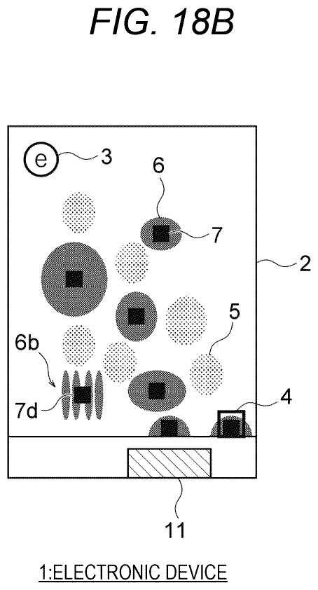

FIGS. 18A and 18B are views illustrating a method of extracting the metastable point 7 according to a tenth embodiment of the present disclosure. When the potential in the electrostatic potential field 2 of the electronic device 1 is calculated, the electrostatic potential field 2 may be divided into meshes, and the potential may be calculated for each mesh-divided element. In this case, a plurality of small valleys 6 derived from the meshes is generated. In FIG. 18A, the plurality of small valleys 6 is referred to as a valley group 6b. Each of the plurality of valleys 6 in the valley group 6b has the metastable point 7. In the tenth embodiment of the present disclosure, as illustrated in FIG. 18B, one or more barriers 9a existing between the plurality of metastable points 7 are extracted, and the plurality of metastable points 7 located around the barriers 9a having a predetermined height or less among the extracted barriers 9a are combined to generate a new metastable point 7d.

With this arrangement, the number of metastable points 7 can be reduced. In practice, a plurality of metastable points 7 derived from the meshes can be combined to reduce the number of metastable points 7. Therefore, when the circuit model 22 is generated as illustrated in FIG. 3E, the number of wirings 23 to be extracted can be reduced, and the calculation can be made faster. Furthermore, since the wiring 23 that becomes noise can be reduced, the prediction accuracy of the transfer characteristic can be improved.

The method of reducing the metastable points 7 according to the tenth embodiment may be applied to the full mesh search method or the like according to the second embodiment. For example, the method of reducing the metastable points 7 according to the present embodiment can be applied to the valley group 6b including the artificial valleys 6 derived and formed from the orthogonal meshes of the second embodiment.

### Eleventh Embodiment

In the first embodiment and the like, the main transport paths 8 are extracted by the NEB method or the like on a basis of the metastable points 7. As described above, in the potential scan method or the like, the barriers 9a can be extracted simultaneously with the metastable points 7. An eleventh embodiment of the present disclosure is characterized by extracting the main transport paths 8 on a basis of the barriers 9a.

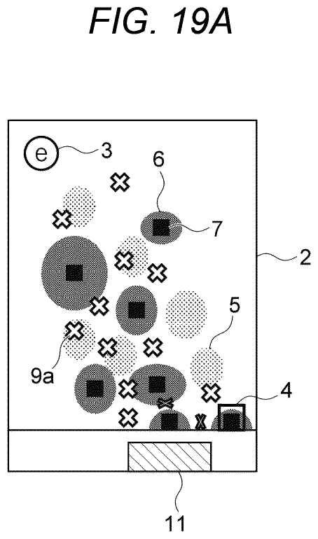

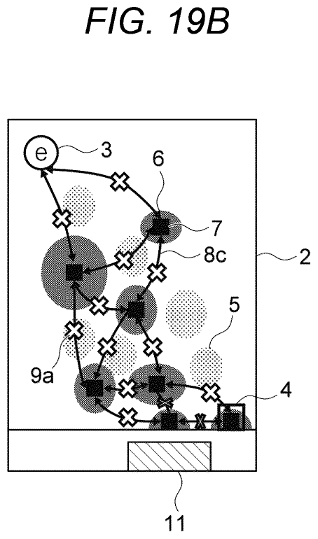

FIGS. 19A and 19B are views illustrating a method of extracting main transport paths 8c according to the eleventh embodiment of the present disclosure. In the example of FIG. 19A, the equipotential surface 92 is scanned with the entire region of the electrostatic potential field 2 or a partial range of the electrostatic potential field 2 as a scan region 90, a plurality of metastable points 7 (for example, positions X₀ and X₂ in FIG. 14) in the entire region or the partial range of the electrostatic potential field 2 is extracted, and peak positions (for example, positions X₁ and X₃ in FIG. 14) of the barriers 9a are extracted from among the plurality of metastable points 7.

In the example of FIG. 19B, the main transport paths 8c are extracted using all the barriers 9a extracted in FIG. 19A. For example, a gradient method is used to extract the main transport paths 8c.

In the gradient method, for example, the initial points are arranged at the peak positions of the barriers 9a, and the initial points are moved little by little in a direction in which the charge transfer obstacle becomes smaller, so that the position where the electron e is most likely to pass between the plurality of metastable points 7 can be extracted. On a basis of the position extracted by the gradient method, the main transport paths 8c can be extracted.

In the eleventh embodiment of the present disclosure, the circuit model 22 can be generated as in FIG. 3E and the like on a basis of the extracted main transport paths 8c. The combined resistance value can be calculated on a basis of the circuit model 22.

In the eleventh embodiment of the present disclosure, by extracting the main transport paths 8c using the gradient method, the calculation can be made faster than the case of using the NEB method or the like.

The method of extracting the main transport paths 8c according to the eleventh embodiment may be applied to the full mesh search method or the like according to the second embodiment.

### Twelfth Embodiment

In the method of extracting the main transport paths 8c according to the eleventh embodiment, the main transport paths 8c are extracted from all the barriers 9a extracted simultaneously with the metastable points 7, but the main transport paths 8c may be extracted from a part of the barriers 9a. For example, the main transport paths 8c may be extracted from the barriers 9a having a predetermined height or less among the extracted barriers 9a.

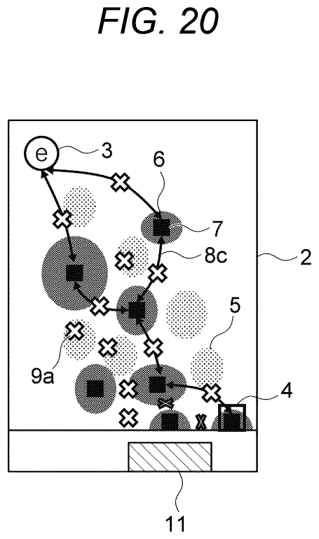

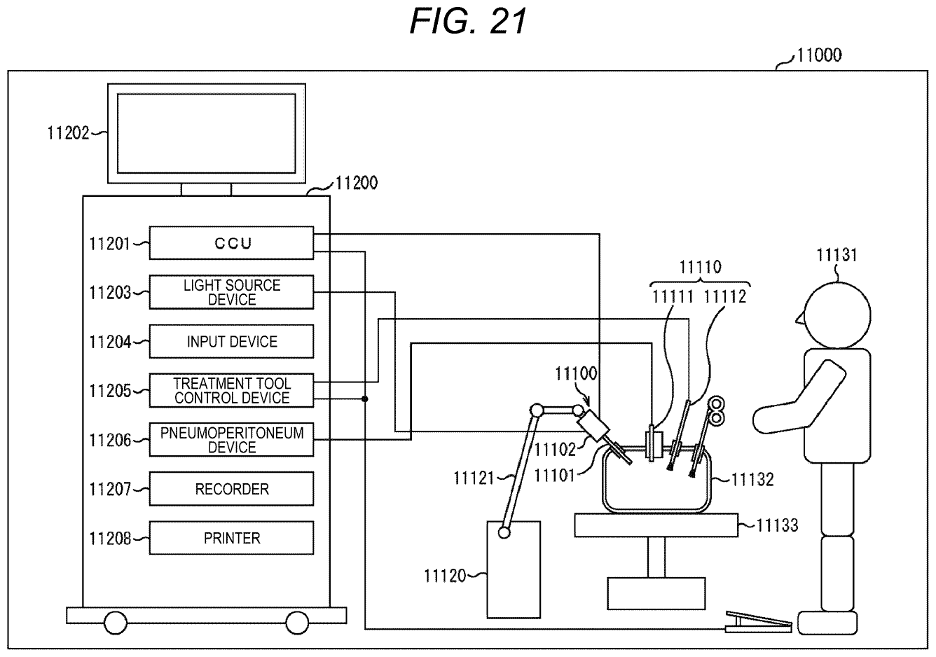

FIG. 20 is a view illustrating a method of extracting the main transport paths 8c according to a twelfth embodiment of the present disclosure. In FIG. 20, the main transport paths 8c are not extracted from the peak position of the high barrier 9a. In the peak position of the high barrier 9a and the vicinity thereof, the possibility that the electron e passes through is low, and the influence on the transport characteristic is small. In the twelfth embodiment of the present disclosure, it is possible to omit extraction of the transfer path having a small influence on the transport characteristic, and it is possible to further reduce the calculation amount from that of the eleventh embodiment.

At least a part of the charge transport characteristic calculation device according to the present embodiment may be configured by hardware or software. In the case of being configured by software, a program for implementing at least some functions of the charge transport characteristic calculation device may be stored in a recording medium such as a flexible disk, a CD-ROM, or the like, and may be read and executed by a computer. The recording medium is not limited to a removable recording medium such as a magnetic disk or an optical disk, and may be a fixed recording medium such as a hard disk device or a memory.

Furthermore, a program for implementing at least some functions of the charge transport characteristic calculation method according to the present embodiment may be distributed via a communication line (including wireless communication) such as the Internet.

Furthermore, the program may be distributed via a wired line or a wireless line such as the Internet or stored in a recording medium in an encrypted, modulated, or compressed state.

### Application Example

The technology according to the present disclosure (present technology) can be applied to various kinds of products. For example, the technology according to the present disclosure may be applied to an endoscopic surgery system.

FIG. 21 is a view illustrating an example of a schematic configuration of an endoscopic surgery system to which the technology according to the present disclosure (the present technology) can be applied.

FIG. 21 illustrates a state in which an operator (doctor) 11131 performs surgery on a patient 11132 on a patient bed 11133, by using an endoscopic surgery system 11000. As illustrated, the endoscopic surgery system 11000 includes an endoscope 11100, other surgical tools 11110 such as a pneumoperitoneum tube 11111 and an energy treatment tool 11112, a supporting arm device 11120 that supports the endoscope 11100, and a cart 11200 on which various types of devices for endoscopic surgery are mounted.

The endoscope 11100 includes a lens barrel 11101 having a region of a predetermined length from a distal end thereof to be inserted into a body cavity of the patient 11132, and a camera head 11102 connected to a proximal end of the lens barrel 11101. In the illustrated example, the endoscope 11100 is illustrated that is formed as a so-called rigid endoscope including the lens barrel 11101 of a rigid type; however, the endoscope 11100 may be formed as a flexible endoscope including the lens barrel 11101 of a flexible type.

The lens barrel 11101 is provided with an opening in which an objective lens is fitted, at the distal end thereof. A light source device 11203 is connected to the endoscope 11100 and light generated by the light source device 11203 is guided by a light guide extending inside the lens barrel 11101 to the distal end of the lens barrel, and applied to an observation target in the body cavity of the patient 11132 via the objective lens. Note that the endoscope 11100 may be a forward-viewing endoscope or may be an oblique-viewing endoscope or a side-viewing endoscope.

An optical system and an imaging element are provided inside the camera head 11102, and reflected light (observation light) from the observation target is condensed on the imaging element by the optical system.

The observation light is photoelectrically converted by the imaging element to generate an electric signal corresponding to the observation light, that is, an image signal corresponding to an observation image. The image signal is transmitted as RAW data to a camera control unit (CCU) 11201.

The CCU 11201 includes a central processing unit (CPU), a graphics processing unit (GPU), or the like, and integrally controls operation of the endoscope 11100 and a display device 11202. Moreover, the CCU 11201 receives the image signal from the camera head 11102 and performs, on the image signal, various types of image processing for displaying an image based on the image signal, for example, development processing (demosaic processing), and the like.

The display device 11202 displays the image based on the image signal, on which the image processing has been performed by the CCU 11201, under the control of the CCU 11201.

The light source device 11203 includes a light source such as, for example, a light emitting diode (LED) and supplies irradiation light upon imaging of a surgical region to the endoscope 11100.

An input device 11204 is an input interface for the endoscopic surgery system 11000. A user can input various types of information and instructions to the endoscopic surgery system 11000 via the input device 11204. For example, the user inputs an instruction to change an imaging condition (type of irradiation light, magnification, focal length, or the like) by the endoscope 11100, or the like.

A treatment tool control device 11205 controls driving of the energy treatment tool 11112 for cautery or incision of tissue, sealing of a blood vessel, or the like. A pneumoperitoneum device 11206 feeds gas into a body cavity of the patient 11132 through the pneumoperitoneum tube 11111 to inflate the body cavity in order to secure a field of view by the endoscope 11100 and secure a working space for the surgeon. A recorder 11207 is a device capable of recording various types of information regarding surgery. A printer 11208 is a device capable of printing various types of information regarding surgery in various types of forms such as a text, an image, or a graph.

Note that the light source device 11203 that supplies irradiation light when a surgical region is to be imaged to the endoscope 11100 can include a white light source including, for example, an LED, a laser light source, or a combination thereof. In a case where the white light source includes a combination of R, G, and B laser light sources, since an output intensity and an output timing can be controlled with high accuracy for each color (each wavelength), adjustment of white balance of a captured image can be performed in the light source device 11203. Furthermore, in this case, it is also possible to capture an image corresponding to each of R, G, and B in a time division manner by irradiating the observation target with laser light from each of the R, G, and B laser light sources in a time-division manner, and controlling driving of the imaging element of the camera head 11102 in synchronization with a timing of the irradiation. According to this method, a color image can be obtained even if color filters are not provided for the imaging element.

Furthermore, driving of the light source device 11203 may be controlled such that the intensity of light to be output is changed for each predetermined time. Driving of the imaging element of the camera head 11102 is controlled in synchronization with a timing of the change of the intensity of light to acquire images in a time division manner and combining the images, whereby it is possible to create an image with a high dynamic range free from so-called blocked up shadows and blown out highlights.

Furthermore, the light source device 11203 may be configured to supply light of a predetermined wavelength band applicable to special light observation. In special light observation, for example, by utilizing wavelength dependency of absorption of light in body tissue to irradiate light of a narrow band in comparison with irradiation light upon ordinary observation (that is, white light), so-called narrow band observation (narrow band imaging) of imaging predetermined tissue such as a blood vessel of a superficial portion of the mucous membrane or the like in a high contrast is performed. Alternatively, in special light observation, fluorescent observation may be performed for obtaining an image from fluorescent light generated by irradiation of excitation light. In fluorescent observation, it is possible to perform observation of fluorescent light from body tissue by irradiating the body tissue with excitation light (autofluorescence observation), or to obtain a fluorescent light image by locally injecting a reagent such as indocyanine green (ICG) into body tissue and irradiating the body tissue with excitation light corresponding to a fluorescent light wavelength of the reagent. The light source device 11203 can be configured to supply such narrow-band light and/or excitation light applicable to special light observation as described above.

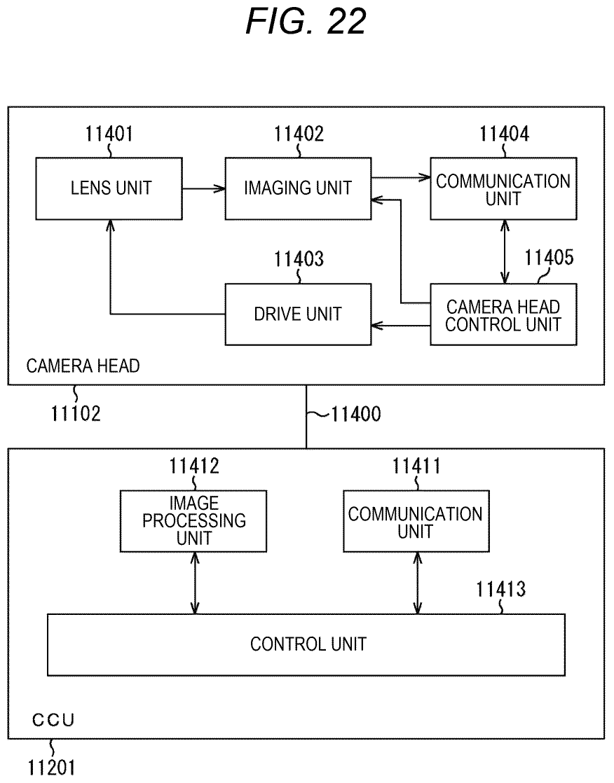

FIG. 22 is a block view illustrating an example of a functional configuration of the camera head 11102 and the CCU 11201 illustrated in FIG. 21.

The camera head 11102 includes a lens unit 11401, an imaging unit 11402, a drive unit 11403, a communication unit 11404 and a camera head control unit 11405. The CCU 11201 includes a communication unit 11411, an image processing unit 11412, and a control unit 11413. The camera head 11102 and the CCU 11201 are communicatively connected to each other by a transmission cable 11400.

The lens unit 11401 is an optical system, provided at a connection portion to the lens barrel 11101. The observation light taken in from the distal end of the lens barrel 11101 is guided to the camera head 11102 and is incident on the lens unit 11401. The lens unit 11401 includes a combination of a plurality of lenses including a zoom lens and a focus lens.

The number of imaging elements included in the imaging unit 11402 may be one (so-called single-plate type) or a plural number (so-called multi-plate type). In a case where the imaging unit 11402 is configured as the multi-plate type, for example, image signals respectively corresponding to R, G and B are generated by the imaging elements, and the image signals may be combined to obtain a color image. The imaging unit 11402 may also be configured so as to have a pair of imaging elements for acquiring respective image signals for the right eye and the left eye applicable to three dimensional (3D) display. The 3D display is performed, whereby depth of living body tissue in a surgical region can be grasped more accurately by the surgeon 11131. Note that in a case where the imaging unit 11402 is configured as the multi-plate type, a plurality of systems of lens units 11401 is provided corresponding to the individual imaging elements.

Furthermore, the imaging unit 11402 may not necessarily be provided in the camera head 11102. For example, the imaging unit 11402 may be provided immediately behind the objective lens, inside the lens barrel 11101.

The drive unit 11403 includes an actuator and moves the zoom lens and the focus lens of the lens unit 11401 by a predetermined distance along the optical axis under the control of the camera head control unit 11405. With this arrangement, a magnification and a focus of a captured image by the imaging unit 11402 can be appropriately adjusted.

The communication unit 11404 includes a communication device for transmitting and receiving various types of information to and from the CCU 11201. The communication unit 11404 transmits an image signal acquired from the imaging unit 11402 as RAW data to the CCU 11201 through the transmission cable 11400.

Furthermore, the communication unit 11404 receives a control signal for controlling driving of the camera head 11102 from the CCU 11201 and supplies the control signal to the camera head control unit 11405. The control signal includes information regarding imaging conditions, for example, information to the effect that a frame rate of the captured image is designated, information to the effect that an exposure value at the time of imaging is designated, and/or information to the effect that the magnification and the focus of the captured image are designated.

Note that the imaging conditions such as the frame rate, exposure value, magnification, and focus described above may be appropriately designated by the user, or may be set automatically by the control unit 11413 of the CCU 11201 on a basis of the acquired image signal. In the latter case, so-called auto exposure (AE) function, auto focus (AF) function, and auto white balance (AWB) function are incorporated in the endoscope 11100.

The camera head control unit 11405 controls driving of the camera head 11102 on a basis of a control signal from the CCU 11201 received through the communication unit 11404.

The communication unit 11411 includes a communication device for transmitting and receiving various types of information to and from the camera head 11102. The communication unit 11411 receives the image signal transmitted from the camera head 11102 through the transmission cable 11400.

Furthermore, the communication unit 11411 transmits the control signal for controlling driving of the camera head 11102 to the camera head 11102. The image signal and the control signal can be transmitted by electrical communication, optical communication, or the like.

The image processing unit 11412 performs various types of image processing on an image signal that is RAW data transmitted from the camera head 11102.

The control unit 11413 performs various types of control regarding imaging of a surgical region or the like by the endoscope 11100 and display of a captured image obtained by imaging of the surgical region or the like. For example, the control unit 11413 creates the control signal for controlling driving of the camera head 11102.

Furthermore, the control unit 11413 causes the display device 11202 to display a captured image in which the surgical region or the like is imaged, on a basis of the image signal subjected to the image processing by the image processing unit 11412. At this time, the control unit 11413 may recognize various types of objects in the captured image by using various types of image recognition technologies. For example, the control unit 11413 can recognize a surgical tool such as forceps, a particular living body region, bleeding, mist when the energy treatment tool 11112 is used, and the like by detecting edge shapes, colors, and the like of the objects included in the captured image. At the time of causing the display device 11202 to display the captured image, the control unit 11413 may display various types of surgery assistance information on the image of the surgical region in a superimposed manner by using a result of the recognition. The surgery assistance information is displayed in a superimposed manner and presented to the surgeon 11131, whereby a burden on the surgeon 11131 can be reduced and the surgeon 11131 can reliably proceed with the surgery.

The transmission cable 11400 that connects the camera head 11102 and the CCU 11201 to each other is an electric signal cable applicable to communication of an electric signal, an optical fiber applicable to optical communication, or a composite cable thereof.

Here, in the illustrated example, communication is performed by wired communication using the transmission cable 11400; however, the communication between the camera head 11102 and the CCU 11201 may be performed by wireless communication.

In the above, an example has been described of the endoscopic surgery system to which the technology according to the present disclosure can be applied. The technology according to the present disclosure may be applied to the imaging unit 11402 of the camera head 11102 in the configuration described above. Specifically, the solid-state imaging device 50 in FIG. 7, with improved quality by the charge transport characteristic calculation method according to the present disclosure can be applied to the imaging unit 11402. By applying the technology according to the present disclosure to the imaging unit 11402, for example, a clearer image of an operative site can be obtained, so that the operator can reliably check the surgical region.

Note that, here, the endoscopic surgery system has been described as an example, but the technology according to the present disclosure may be applied to, for example, a microscopic surgery system, or the like.

Note that the present technology can have the following configurations.
(1) A charge transport characteristic calculation method including:
a procedure of calculating an electrostatic potential of an electronic device;
a procedure of extracting a plurality of metastable points in an electrostatic potential field of the electronic device;
a procedure of extracting a plurality of paths for transporting a charge from a charge generation position to a charge readout position of the electronic device via the plurality of metastable points in the electrostatic potential field;
a procedure of calculating a physical quantity of the electrostatic potential field in each of the plurality of paths; and
a procedure of calculating a charge transport characteristic from the charge generation position to the charge readout position on a basis of the physical quantity of the electrostatic potential field in each of the plurality of paths.
(2) The charge transport characteristic calculation method according to (1), in which
the metastable point is a minimum point of the electrostatic potential field.
(3) The charge transport characteristic calculation method according to (2), in which
the charge transported by the electronic device is a positive charge or a negative charge, and
the metastable point is a minimum point of the electrostatic potential of the electronic device in a case where the electronic device transports the negative charge, and is a minimum point after sign inversion of the electrostatic potential of the electronic device in a case where the electronic device transports the positive charge.
(4) The charge transport characteristic calculation method according to (3), in which
the charge for which the charge transport characteristic is calculated is at least one of a hole, a cation, an electron, or an anion.
(5) The charge transport characteristic calculation method according to any one of (2) to (4), in which
in the procedure of extracting the plurality of metastable points, a plurality of the minimum points is extracted according to a gradient of an electric field of the electrostatic potential field.
(6) The charge transport characteristic calculation method according to (5), in which
in the procedure of extracting the plurality of metastable points, a plurality of initial points is set in the electrostatic potential field, and all the minimum points in the electrostatic potential field are extracted on a basis of the electric field at the plurality of initial points.
(7) The charge transport characteristic calculation method according to any one of (2) to (4), in which
in the procedure of extracting the plurality of metastable points, the electrostatic potential field is mesh-divided, and points at which an electric field at each lattice point of a mesh is zero and a differential value of the electric field is positive are extracted as the metastable points.
(8) The charge transport characteristic calculation method according to any one of (2) to (4), in which
in the procedure of extracting the plurality of metastable points, an equipotential surface having a same potential is moved while changing the potential in the electrostatic potential field of the electronic device, and a portion where at least a part of the equipotential surface disappears is extracted as the metastable point.
(9) The charge transport characteristic calculation method according to (8), in which
in the procedure of extracting the plurality of metastable points, the equipotential surface is moved to extract the metastable points in a predetermined space region in which the charge generated in the electronic device is movable.
(10) The charge transport characteristic calculation method according to (8) or (9), in which
in the procedure of extracting the plurality of metastable points, the equipotential surface is moved within a predetermined potential range in the electrostatic potential field to extract the metastable points.
(11) The charge transport characteristic calculation method according to any one of (8) to (10), in which
in the procedure of extracting the plurality of metastable points, in a case where a plurality of the portions exists on the equipotential surface, a barrier representing a magnitude of a charge transfer obstacle is extracted from among the plurality of portions.

(12) The charge transport characteristic calculation method according to (11), in which
in the procedure of extracting the plurality of metastable points, the plurality of metastable points located around the barrier having a predetermined height or less is combined.
(13) The charge transport characteristic calculation method according to (11) or (12), in which
in the procedure of extracting the plurality of paths, the plurality of paths is extracted from a peak position of the barrier on a basis of a gradient method.
(14) The charge transport characteristic calculation method according to (13), in which
in the procedure of extracting the plurality of paths, the plurality of paths is extracted from the peak position of the barrier having a predetermined height or less on a basis of a gradient method.
(15) The charge transport characteristic calculation method according to any one of (1) to (11), in which
in the procedure of extracting the plurality of paths, the plurality of paths is extracted by using a nudged elastic band (NEB) method, a string method, a conjugate peak refinement (CPR) method, a ridge method, or a Dewar, Healy, and Stewart (DHS) method.
(16) The charge transport characteristic calculation method according to any one of (1) to (11), in which
in the procedure of extracting the plurality of paths, the plurality of paths is extracted by using a drag method.
(17) The charge transport characteristic calculation method according to (15) or (16), in which
in the procedure of extracting the plurality of paths, a path having a smaller electrostatic potential is preferentially selected from among paths between any two metastable points included in the plurality of metastable points to extract the plurality of paths.
(18) The charge transport characteristic calculation method according to any one of (1) to (17), in which
in the procedure of calculating the physical quantity, a barrier representing a magnitude of a charge transfer obstacle in each of the plurality of extracted paths is calculated as the physical quantity.
(19) The charge transport characteristic calculation method according to (18), in which
in the procedure of calculating the physical quantity, resistance values of the plurality of paths in a circuit model corresponding to the electrostatic potential field are calculated as the barrier.
(20) The charge transport characteristic calculation method according to (19), in which
in the procedure of calculating the charge transport characteristic, a combined resistance value obtained by combining the resistance values of the plurality of paths in the circuit model is calculated.
(21) The charge transport characteristic calculation method according to (20), in which
in the procedure of calculating the charge transport characteristic, the combined resistance value is calculated in consideration of the resistance value less than a predetermined threshold without considering the resistance value greater than or equal to the predetermined threshold.
(22) The charge transport characteristic calculation method according to any one of (1) to (21), in which
in the procedure of calculating the charge transport characteristic, the charge transport characteristic is calculated on a basis of a value obtained by multiplying physical quantities of the plurality of paths by probabilities of selecting the plurality of paths.
(23) The charge transport characteristic calculation method according to any one of (1) to (22), in which
in the procedure of extracting the plurality of paths, in a case where the electronic device is a solid-state imaging device, the charge generation position is obtained from a charge generation distribution in a photoelectric conversion region.
(24) The charge transport characteristic calculation method according to (23), in which
in the procedure of extracting the plurality of paths, the charge readout position is set in accordance with a position of a transfer electrode.
(25) A charge transport characteristic calculation device including:
a first calculation unit that calculates an electrostatic potential of an electronic device;
a first extraction unit that extracts a plurality of metastable points in an electrostatic potential field of the electronic device;
a second extraction unit that extracts a plurality of paths for transporting a charge from a charge generation position to a charge readout position of the electronic device via the plurality of metastable points in the electrostatic potential field;
a second calculation unit that calculates a physical quantity of the electrostatic potential field in each of the plurality of paths; and
a third calculation unit that calculates a charge transport characteristic from the charge generation position to the charge readout position on a basis of the physical quantity of the electrostatic potential field in each of the plurality of paths.

Aspects of the present disclosure are not limited to the above-described individual embodiments, but include various modifications that can be conceived by those skilled in the art, and the effects of the present disclosure are not limited to the above-described contents. In other words, various additions, modifications, and partial deletions may be made without departing from the conceptual idea and spirit of the present disclosure derived from the matters defined in the claims and equivalents thereof.

### REFERENCE SIGNS LIST

1, la Electronic device
2, 2a, 2b Electrostatic potential field
3, 3a Charge generation position
4 Charge readout position
5, 5a Mountain
6, 6a Valley
6b Valley group
7, 7a, 7b, 7c, 7d, 70, 71a, 71b, 71c Metastable point
8, 8a, 8b, 8c, 72a, 72b, 72c Main transport path
9, 9a, 73a, 73b, 73c Barrier
11 Transfer electrode
21 Initial point
22, 22a, 22b Circuit model
23 Wiring
24 Connection node
25 Resistor
31 Transport path
32a, 32b, 32c Saddle point
33 Straight line
34 Surface
40 Charge transport characteristic calculation device
41 Electrostatic potential calculation unit
42 Metastable point extraction unit
43 Main transport path extraction unit
44 Circuit model generation unit
45 Charge transport characteristic calculation unit
50 Solid-state imaging device
51 Incident light
52 Lens
53 Color filter
54, 54a Photoelectric conversion region
60 Mesh
61 Lattice point
80 Charge generation distribution
90, 90a Scan region
90b, 93a, 94a Potential range
91 VG region
92, 92a, 92b, 92c, 92d, 92e, 92f Equipotential surface
93 P-Well region
94 FD diffusion layer

1. A charge transport characteristic calculation method comprising:
a procedure of calculating an electrostatic potential of an electronic device;
a procedure of extracting a plurality of metastable points in an electrostatic potential field of the electronic device;
a procedure of extracting a plurality of paths for transporting a charge from a charge generation position to a charge readout position of the electronic device via the plurality of metastable points in the electrostatic potential field;
a procedure of calculating a physical quantity of the electrostatic potential field in each of the plurality of paths; and
a procedure of calculating a charge transport characteristic from the charge generation position to the charge readout position on a basis of the physical quantity of the electrostatic potential field in each of the plurality of paths.

2. The charge transport characteristic calculation method according to claim 1, wherein
the metastable point is a minimum point of the electrostatic potential field.

3. The charge transport characteristic calculation method according to claim 2, wherein
the charge transported by the electronic device is a positive charge or a negative charge, and
the metastable point is a minimum point of the electrostatic potential of the electronic device in a case where the electronic device transports the negative charge, and is a minimum point after sign inversion of the electrostatic potential of the electronic device in a case where the electronic device transports the positive charge.

4. The charge transport characteristic calculation method according to claim 3, wherein
the charge for which the charge transport characteristic is calculated is at least one of a hole, a cation, an electron, or an anion.

5. The charge transport characteristic calculation method according to claim 2, wherein
in the procedure of extracting the plurality of metastable points, a plurality of the minimum points is extracted according to a gradient of an electric field of the electrostatic potential field.

6. The charge transport characteristic calculation method according to claim 5, wherein
in the procedure of extracting the plurality of metastable points, a plurality of initial points is set in the electrostatic potential field, and all the minimum points in the electrostatic potential field are extracted on a basis of the electric field at the plurality of initial points.

7. The charge transport characteristic calculation method according to claim 2, wherein
in the procedure of extracting the plurality of metastable points, the electrostatic potential field is mesh-divided, and points at which an electric field at each lattice point of a mesh is zero and a differential value of the electric field is positive are extracted as the metastable points.

8. The charge transport characteristic calculation method according to claim 2, wherein
in the procedure of extracting the plurality of metastable points, an equipotential surface having a same potential is moved while changing the potential in the electrostatic potential field of the electronic device, and a portion where at least a part of the equipotential surface disappears is extracted as the metastable point.

9. The charge transport characteristic calculation method according to claim 8, wherein
in the procedure of extracting the plurality of metastable points, the equipotential surface is moved to extract the metastable points in a predetermined space region in which the charge generated in the electronic device is movable.

10. The charge transport characteristic calculation method according to claim 8, wherein
in the procedure of extracting the plurality of metastable points, the equipotential surface is moved within a predetermined potential range in the electrostatic potential field to extract the metastable points.

11. The charge transport characteristic calculation method according to claim 8, wherein
in the procedure of extracting the plurality of metastable points, in a case where a plurality of the portions exists on the equipotential surface, a barrier representing a magnitude of a charge transfer obstacle is extracted from among the plurality of portions.

12. The charge transport characteristic calculation method according to claim 11, wherein
in the procedure of extracting the plurality of metastable points, the plurality of metastable points located around the barrier having a predetermined height or less is combined.

13. The charge transport characteristic calculation method according to claim 11, wherein
in the procedure of extracting the plurality of paths, the plurality of paths is extracted from a peak position of the barrier on a basis of a gradient method.

14. The charge transport characteristic calculation method according to claim 13, wherein
in the procedure of extracting the plurality of paths, the plurality of paths is extracted from the peak position of the barrier having a predetermined height or less on a basis of a gradient method.

15. The charge transport characteristic calculation method according to claim 1, wherein
in the procedure of extracting the plurality of paths, the plurality of paths is extracted by using a nudged elastic band (NEB) method, a string method, a conjugate peak refinement (CPR) method, a ridge method, or a Dewar, Healy, and Stewart (DHS) method.

16. The charge transport characteristic calculation method according to claim 1, wherein
in the procedure of extracting the plurality of paths, the plurality of paths is extracted by using a drag method.

17. The charge transport characteristic calculation method according to claim 15, wherein
in the procedure of extracting the plurality of paths, a path having a smaller electrostatic potential is preferentially selected from among paths between any two metastable points included in the plurality of metastable points to extract the plurality of paths.

18. The charge transport characteristic calculation method according to claim 1, wherein
in the procedure of calculating the physical quantity, a barrier representing a magnitude of a charge transfer obstacle in each of the plurality of extracted paths is calculated as the physical quantity.

19. The charge transport characteristic calculation method according to claim 18, wherein
in the procedure of calculating the physical quantity, resistance values of the plurality of paths in a circuit model corresponding to the electrostatic potential field are calculated as the barrier.

20. The charge transport characteristic calculation method according to claim 19, wherein
in the procedure of calculating the charge transport characteristic, a combined resistance value obtained by combining the resistance values of the plurality of paths in the circuit model is calculated.

21. The charge transport characteristic calculation method according to claim 20, wherein
in the procedure of calculating the charge transport characteristic, the combined resistance value is calculated in consideration of the resistance value less than a predetermined threshold without considering the resistance value greater than or equal to the predetermined threshold.

22. The charge transport characteristic calculation method according to claim 1, wherein
in the procedure of calculating the charge transport characteristic, the charge transport characteristic is calculated on a basis of a value obtained by multiplying physical quantities of the plurality of paths by probabilities of selecting the plurality of paths.

23. The charge transport characteristic calculation method according to claim 1, wherein
in the procedure of extracting the plurality of paths, in a case where the electronic device is a solid-state imaging device, the charge generation position is obtained from a charge generation distribution in a photoelectric conversion region.

24. The charge transport characteristic calculation method according to claim 23, wherein
in the procedure of extracting the plurality of paths, the charge readout position is set in accordance with a position of a transfer electrode.

25. A charge transport characteristic calculation device comprising:
a first calculation unit that calculates an electrostatic potential of an electronic device;
a first extraction unit that extracts a plurality of metastable points in an electrostatic potential field of the electronic device;
a second extraction unit that extracts a plurality of paths for transporting a charge from a charge generation position to a charge readout position of the electronic device via the plurality of metastable points in the electrostatic potential field;
a second calculation unit that calculates a physical quantity of the electrostatic potential field in each of the plurality of paths; and
a third calculation unit that calculates a charge transport characteristic from the charge generation position to the charge readout position on a basis of the physical quantity of the electrostatic potential field in each of the plurality of paths.
